(19) United States
(12) Patent Application Publication
(10) Pub. No.: US 2015/0259566 A1
(43) Pub. Date: Sep. 17, 2015

(54) METHODS FOR PROVIDING A LOW GLOSS POLYURETHANE COATING ON A SUBSTRATE

(71) Applicant: Bayer MaterialScience LLC, Pittsburgh, PA (US)

(72) Inventors: Julia Broglie, McMurray, PA (US); William Corso, Coraopolis, PA (US); Jeffrey Dormish, Upper St. Clair, PA (US); Lyubov Gindin, Pittsburgh, PA (US); Suzanne Holt, McDonald, PA (US)

(73) Assignee: Bayer MaterialScience LLC, Pittsburgh, PA (US)

(21) Appl. No.: 14/203,953

(22) Filed: Mar. 11, 2014

(51) Int. Cl. C09D 175/04

(52) U.S. Cl. CPC C09D 175/04

(57) ABSTRACT

Disclosed are methods for coating a substrate. These methods include: (a) preparing a two-component coating composition by mixing a first component and a second component to make a mixture thereof, and (b) depositing the mixture over the substrate to form a film having a 60° gloss of no more than 35 gloss units (measured according to ASTM D523-89). In these methods: (i) the first component includes: (A) an aqueous anionic, aliphatic polyurethane dispersion comprising a polyurethane having terminal methylol groups; and (ii) the second component comprises an aqueous anionic acrylic polymer solution having a viscosity of 25,000 to 60,000 mPa·s at 20° C. when measured according to DIN EN ISO 3219 at a non-volatile content of 9% to 11% by weight, based on the total weight of the solution, measured according to DIN 53189.

### FIELD OF THE INVENTION

The present invention relates to methods for providing a low gloss polyurethane coating on a substrate, as well as the substrates coated therewith. The low gloss coatings are deposited from a coating composition comprising an aqueous anionic, aliphatic polyurethane dispersion.

### BACKGROUND

Polyurethane coatings are used in many applications because they exhibit many advantageous properties. In some cases, polyurethane coatings having a matte, i.e., very low gloss finish is desired. In fact, in some cases, a 60° gloss even as low as 2 or less is desired. One such application is to provide a matte appearance to synthetic leather, such as synthetic leathers made from polyvinyl chloride (PVC) and other polymers, such as polyurethanes. Synthetic leathers are often used in the manufacture of furniture, clothing and shoes, and vehicle seats, among many other products and can be desirable since they serve as a replacement for real leather that uses animal skin.

Typically, very low gloss coatings are produced by incorporating matting (or flatting) agents, which are fine particle powders of organic and/or inorganic materials that often have a particle size of 1 to 20 microns. They can be made from a variety of materials, such as silica, silicate, polymeric beads, talc, alumina, calcium carbonate, calcium stearate, zinc stearate, aluminum rosinate, and clay.

A problem with such matting agents, however, is that when used in an amount needed to produce coatings of very low gloss, such as a 60° gloss of 5 or below or 2 or below, the mechanical and chemical properties of the resulting coating are significantly detrimentally affected, since the amount of matting agent required is such that the weight ratio of matting agent to binder that is used is very high. In these applications, for example, it is not uncommon to require over 20% by weight of matting agent in the composition, based on total composition weight, in order to obtain the desired very low 60° gloss coating. Properties that can be negatively affected by inclusion of large quantities of matting agent include, for example, reduced adhesion of the coating to the substrate, reduced coating flexibility, and reduced coating hardness.

As a result, alternative methods for providing a very low gloss polyurethane coating on a substrate, such as a synthetic leather substrate, are desired.

### SUMMARY OF THE INVENTION

In some respects, the present invention is directed to methods for coating a substrate. These methods comprise depositing a two-component coating composition comprising a first component and a second component over the substrate to form a film having a 60° gloss of no more than 35 gloss units measured according to ASTM D523-89, wherein: (i) the first component comprises an aqueous anionic, aliphatic polyurethane dispersion comprising a polyurethane having terminal methylol groups; and (ii) the second component comprises an aqueous anionic acrylic polymer solution having a viscosity of 25,000 to 60,000 mPa·s at 20° C. when measured according to DIN EN ISO 3219 at a non-volatile content of 9% to 11% by weight, based on the total weight of the solution, measured according to DIN 53189.

In other respects, the present invention is directed to methods for making an aqueous polyurethane dispersion. These methods comprise: (a) mixing a first component and a second component to make a mixture thereof, wherein: (1) the first component comprises a first aqueous anionic, aliphatic polyurethane dispersion comprising a polyurethane having terminal methylol groups; and (2) the second component comprises an aqueous anionic acrylic polymer solution having a viscosity of 25,000 to 60,000 mPa·s at 20° C. measured according to DIN EN ISO 3219 at a non-volatile content of 9% to 11% by weight, based on total weight of the solution, measured according to DIN 53189, for a time and under conditions so as to disperse (2) in the mixture; and (b) adding a second aqueous polyurethane dispersion, different from (1), to the mixture of step (a) such that the resin solids content of the aqueous polyurethane dispersion is less than 50% by weight, based on the total weight of the aqueous polyurethane dispersion.

In still other respects, the present invention is directed to methods for coating a substrate, comprising depositing a two-component coating composition comprising a first component and a second component to make a mixture thereof over the substrate within 2 hours after the mixture has been prepared to form a film having a 60° gloss of no more than 35 gloss units measured according to ASTM D523-89, wherein: (i) the first component comprises an aqueous anionic, aliphatic polyether-polyurethane dispersion comprising a polyurethane having terminal methylol groups and sulfonate groups and comprising a reaction product of a hydrophilically modified acylated amine functional polyurethane prepolymer and formaldehyde; (ii) the second component comprises an aqueous anionic acrylic polymer solution having a viscosity of 25,000 to 60,000 mPa·s at 20° C. when measured according to DIN EN ISO 3219 at a non-volatile content of 9% to 11% by weight, based on the total weight of the solution, measured according to DIN 531899, wherein (ii) is present in the coating composition in an amount such that the acrylic polymer that is in the solution is present in an amount of 0.2 to 1 percent by weight, based on the weight of resin solids in (i); and (iii) the resin solids content of the mixture is less than 50% by weight, based on the total weight of the coating composition.

The present invention also relates to, inter alia, related substrates, such as artificial leather substrates, at least partially coated with a low gloss coating.

### BRIEF DESCRIPTION OF THE DRAWINGS

FIG. 1 is a collection of 2D AFM height images of films from Examples 10A-10D; and

FIG. 2 is a collection of 3D AFM height images of films from Examples 10A-10D.

### DETAILED DESCRIPTION OF THE INVENTION

Various embodiments are described and illustrated in this specification to provide an overall understanding of the structure, function, operation, manufacture, and use of the disclosed products and processes. The various embodiments described and illustrated in this specification are non-limiting and non-exhaustive. Thus, the invention is not limited by the description of the various non-limiting and non-exhaustive embodiments disclosed in this specification. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. §112 and 35 U.S.C. §132(a). The various embodiments disclosed and described in this specification can comprise, consist of, or consist essentially of the features and characteristics as variously described herein.

Any patent, publication, or other disclosure material identified herein is incorporated herein by reference in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference herein to “certain embodiments”, “some embodiments”, “various non-limiting embodiments,” or the like, means that a particular feature or characteristic may be included in an embodiment. Thus, use of such phrases, and similar phrases, herein does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments. Such modifications and variations are intended to be included within the scope of the present specification. In this manner, the various embodiments described in this specification are non-limiting and non-exhaustive.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification such that amending to expressly recite any such sub-ranges would comply with the requirements of 35 U.S.C. §112 and 35 U.S.C. §132(a).

The grammatical articles “a”, “an”, and “the”, as used herein, are intended to include “at least one” or “one or more”, unless otherwise indicated, even if “at least one” or “one or more” is used in certain instances. Thus, the articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, “polymer” encompasses prepolymers, oligomers and both homopolymers and copolymers; the prefix “poly” in this context referring to two or more. As used herein, the term “molecular weight”, when used in reference to a polymer, refers to the number average molecular weight, unless otherwise specified.

As used herein, the term “aliphatic” refers to organic compounds characterized by substituted or un-substituted straight, branched, and/or cyclic chain arrangements of constituent carbon atoms. Aliphatic compounds do not contain aromatic rings as part of the molecular structure of the compounds. As used herein, the term “cycloaliphatic” refers to organic compounds characterized by arrangement of carbon atoms in closed ring structures. Cycloaliphatic compounds do not contain aromatic rings as part of the molecular structure of the compounds. Therefore, cycloaliphatic compounds are a subset of aliphatic compounds and thus an aliphatic composition may comprise an aliphatic compound and/or a cycloaliphatic compound.

As used herein, “diisocyanate” refers to a compound containing two isocyanate groups. As used herein, “polyisocyanate” refers to a compound containing two or more isocyanate groups. Hence, diisocyanates are a subset of polyisocyanates.

As indicated, embodiments of the present invention are directed to methods for coating a substrate. Any of a variety of substrates are suitable, such as those at least partially constructed of metal, plastic, ceramic, glass, or natural materials, including those that have been subjected to any pre-treatment that may be desirable. In some embodiments, the composition that is deposited over the substrate in the methods described herein is employed as a topcoat. “Topcoat”, as used herein, refers to an outermost coating layer on a substrate, that is, a layer that is in contact with the external environment and that is coated over other layers, if any other layers are present (if no other coatings are present then the topcoat is deposited directly to the substrate).

In certain embodiments of the present invention, the substrate comprises a textile, such as synthetic leather, which refers herein to a durable and flexible material that is intended as a substitute for animal rawhide and skin. In some embodiments, the synthetic leather is made from PVC and/or a polyurethane. In certain embodiments of the present invention, the substrate comprises upholstery, an article of clothing, a shoe, or an automotive seat, door panels, and automotive instrument panels.

In the methods of the present invention, a two-component coating composition is prepared by mixing a first component and a second component to make a dispersed mixture thereof. As used herein, the term “two-component composition”, therefore, refers to a composition comprising at least two components that are stored in separate containers and are mixed to create a dispersed mixture thereof shortly before application of the mixture to a substrate. Specifically, in embodiments of the two-component compositions used in the present invention, the first component and the second component are mixed to make a dispersed mixture thereof within 2 hours, or, in some cases, within 1 hour, before application of the mixture to a substrate.

In the present methods, the mixture is deposited over the substrate to form a film having a 60° gloss of no more than 35 gloss units, such as no more than 30 gloss units, no more than 25 gloss units, no more than 20 gloss units, no more than 15 gloss units, such as no more than 14, no more than 13, no more than 12, no more than 11, no more than 10 gloss units, no more than 9 gloss units, or, in some cases, no more than 8 gloss units (measured according to ASTM D523-89). In other embodiments, such as those in which an amount of flatting agent is employed (as described below), a film is formed having a 60° gloss of no more than 6 gloss units, no more than 5 gloss units, such as no more than 4, no more than 3, or no more than 2 gloss units (measured according to ASTM D523-89). In addition, the film has an optically uniform appearance, which, as used herein, means that the film is free of any “swirls” or “streaks” that are visible to the naked eye.

As indicated, in the methods of the present invention, the first component comprises an aqueous anionic, aliphatic polyurethane dispersion comprising a polyurethane having terminal methylol groups. Such dispersions can be prepared, for example, according to a “melt dispersion” process disclosed in U.S. Pat. No. 3,756,992 in which isocyanate end groups of a hydrophilically modified prepolymer are reacted with urea, ammonia, or other suitable compounds under solvent free conditions to form acylated amines which in turn are converted into methylol groups by a reaction with formaldehyde before, during or after the addition of water.

As used herein, the term “dispersion” refers to a heterogeneous two-phase water/polymer system in which water principally or exclusively forms the continuous phase and the polymer(s) principally or exclusively comprises the dispersed phase, though the presence of other materials in the continuous phase or dispersed phase is not precluded. The term also covers sedimenting suspensions with particle diameters above approximately 5 microns, as well as colloidal solutions or sols with particle diameters of about 10 microns to 100 microns. The term does not, however, include optically clear, homogeneous aqueous solutions. The term “polyurethane dispersion” refers to a dispersion in which the polymer comprises a polyurethane.

In certain embodiments, the polyurethane dispersion is a reaction product of one or more polyisocyanates and one or more polyols. The reaction product may be reacted with one or more chain-extending compounds. In some cases, at least one of: (a) the one or more polyols, or (b) the one or more chain-extending compounds, are hydrophilic and/or contain anionic or potentially anionic groups. At least one chain-extending compound may comprise an anionic or potentially anionic group and at least two groups which are reactive to isocyanate groups. The reaction product, in some embodiments, comprises residual isocyanate chain ends that are reacted to form acylated amines which in turn are converted into methylol groups by a reaction with formaldehyde before, during or after the addition of water.

As mentioned, in certain embodiments, the foregoing reaction product, which is a polyurethane, comprises terminal isocyanate groups. As used herein, the term “polyurethane” refers to any polymer or oligomer comprising urethane (i.e., carbamate) groups, urea groups, or both. Thus, the term “polyurethane” as used herein refers collectively to polyurethanes, polyureas, and polymers containing both urethane and urea groups, unless otherwise indicated.

Polyurethanes used herein comprise segments comprising one or more polyisocyanates. Suitable polyisocyanates include, for example, diisocyanates having a molecular weight of from about 112 to 1,000, such as 140 to 400. In some embodiments, the polyisocyanate comprises a diisocyanate represented by the formula X(NCO)₂, with X representing a divalent aliphatic hydrocarbon radical having from 4 to 18 carbon atoms, a divalent cycloaliphatic hydrocarbon radical having from 5 to 15 carbon atoms, a divalent aromatic hydrocarbon radical having from 6 to 15 carbon atoms or a divalent araliphatic hydrocarbon radical having from 7 to 15 carbon atoms. Examples of such diisocyanates include, but are not limited to, tetramethylene diisocyanate; methylpentamethylene diisocyanate; 1,6-hexamethylene diisocyanate (HDI); dodecamethylene diisocyanate; 1,3-diisocyanatocyclohexane; 1,4-diisocyanatocyclohexane; 1-isocyanato-3,3,5-trimethyl-3-isocyanatomethyl cyclohexane (isophorone diisocyanate or IPDI); 1-isocyanato-3,3,5-trimethyl-5-isocyanatomethyl cyclohexane; 4,4′-diisocyanatobenzene; bis-(4-isocyanatocyclohexyl)-methane (dicyclohexylmethane diisocyanate); 1,3- and 1,4-bis(isocyanatomethyl)-cyclohexane; bis-(4-isocyanato-3-methyl-cyclohexyl)-methane; toluene diisocyanate (TDI); 2,4-diisocyanatotoluene; 2,6-diisocyanatotoluene; hydrogenated toluene diisocyanate; 4,4′-, 2,2′- and 2,4′-diisocyanatodiphenylmethane (MDI monomers); p-xylylene diisocyanate; m-tetramethylxylene diisocyanate; p-isopropylidene diisocyanate; 1,3- and 1,4-diisocyanatomethyl benzene; 1,5-diisocyanato naphthalene, and combinations of any of these compounds and/or isomers of any of these compounds. Mixtures of diisocyanates are also suitable, such as a mixture of one or more aliphatic diisocyanates and one or more cycloaliphatic diisocyanates.

Higher-functional and/or modified polyisocyanates are also suitable, examples of which include diisocyanate reaction products including, for example, compounds with urethane groups, urea groups, allophanate groups, biuret groups, uretdione groups (isocyanate dimer), and/or isocyanurate groups (isocyanate trimer).

The polyurethanes used herein comprise segments derived from one or more polyols. As used herein, the term “polyol” refers to any organic compound which has at least two (2) free hydroxyl groups per molecule. In various embodiments, polyols may be hydrophilic and/or comprise anionic or potentially anionic groups, such as carboxyl groups; carboxylate groups; sulfonic acid groups; sulfonate groups, or combinations of any thereof. Carboxyl groups and sulfonic acid groups are potentially anionic groups, whereas, carboxylate groups and sulfonate groups are anionic groups in the form of a salt, such as, for example, a sodium salt. Potentially anionic acid groups may be neutralized and converted into anionic groups with base compounds, such as, for example, alkali metal hydroxides, alkali metal hydrogen carbonates, alkali metal carbonates or primary amines, secondary amines or tertiary amines, such as diisopropyl ethylamine, triisopropanolamine, trimethyl amine, triethyl amine, triisopropyl amine, tributyl amine, among many others.

In certain embodiments, the polyol has number average molecular weight of 700 to 16,000. Examples of such relatively high molecular weight polyols include polyester polyols, polyether polyols, polycarbonate palyols, polylactones, polyhydroxy polyacetals, polyacrylates polyols, polyhydroxy polyamides, polyhydroxy polyester amides, polyhydroxy polyalkadienes, polyhydroxy polythioethers, and combinations thereof. These polyols may comprise from 2 to 8 free hydroxyl groups per molecule.

In certain embodiments, suitable polymeric polyols may comprise two (2) free hydroxyl groups. For example, linear polyester diols may be used. Polyester polyols may be prepared from aliphatic, cycloaliphatic or aromatic dicarboxylic or polycarboxylic acids and polyhydroxyl alcohols. Examples of suitable dicarboxylic or polycarboxylic acids for preparing polyester polyols include, but are not limited to, succinic acid, glutaric acid, adipic acid, pimelic acid, suberic acid, azelaic acid, sebacic acid, nonanedicarboxylic acid, decanedicarboxylic acid, terephthalic acid, isophthalic acid, o-phthalic acid, tetrahydrophthalic acid, hexahydrophthalic acid or trimellitic acid, as well as acid anhydrides (such as, for example, o-phthalic acid anhydride, trimellitic acid anhydride or succinic acid anhydride), or combinations of any thereof. Examples of polyhydroxyl alcohols that may be useful in the preparation of polyester polyols include, but are not limited to, ethanediol, diethylene glycol, triethylene glycol, tetraethylene glycol, 1,2-propanediol, dipropylene glycol, tripropylene glycol, tetrapropylene glycol, 1,3-propanediol, 1,4-butanediol, 1,3-butanediol, 2,3-butanediol, 1,5-pentanediol, 1,6-hexanediol; 2,2-dimethyl-1,3-propanediol (neopentyl glycol), 1,4-dihydroxycyclohexane, 1,4-dimethylolcyclohexane, 1,8-octanediol, 1,10-decanediol, 1,12-dodecanediol and combinations of any thereof.

Polyhydroxyl alcohols may also include higher-functional polyols such as trimethylolpropane or glycerol. Cycloaliphatic and/or aromatic dihydroxyl and polyhydroxyl compounds may also be suitable as polyhydroxyl alcohol(s) for the preparation of polyester polyol(s). The corresponding polycarboxylic acid anhydrides or corresponding polycarboxylic acid esters of low alcohols, or mixtures thereof, may also be used in place of the free polycarboxylic acid for the preparation of the polyesters.

Suitable polyester polyols may also be homopolymers or copolymers of lactones, which may be obtained by addition reactions of lactones or lactone mixtures, such as butyrolactone, ε-caprolactone and/or methyl-ε-caprolactone with the suitable difunctional and/or higher-functional starter molecules such as, for example, the polyhydroxyl alcohols mentioned above as structural components for polyester polyols.

Mixtures of one or more dicarboxylic acids and one or more dihydroxyl compounds may be used to prepare polyester polyols. For example, a polyester polyol comprising the reaction product of one (1) dicarboxylic acid and two (2) dihydroxyl compounds may be used. One specific example that may be used is a reaction product of adipic acid, neopentyl glycol and hexanediol.

Polyether polyols and monols may also be used. Suitable polyether polyols may be obtained by reaction of compounds which contain reactive hydrogen atoms with alkylene oxides, such as ethylene oxide, propylene oxide, butylene oxide, styrene oxide, tetrahydrofuran, epichlorohydrin, or a combination thereof. The polyaddition products of these oxides, as well as co-addition and graft products thereof, as well as polyether polyols obtained by condensation of polyhydroxyl alcohols or mixtures thereof and the polyether polyols obtained by alkoxylation of polyhydroxyl alcohols, amines and amino-alcohols, also may be used.

In various embodiments, polyether polyols may comprise a homopolymer, copolymer, or graft polymer of propylene oxide and ethylene oxide, which are obtained by addition reactions of epoxides with low molecular weight diols or triols or with higher-functional low molecular weight polyols such as, for example, pentaerythritol or a sugar alcohol, or with water. Polyether monols may comprise a homopolymer, copolymer or graft polymer of propylene oxide and ethylene oxide, which are obtained by addition reaction of epoxides with low molecular weight mono-hydroxyl alcohols (e.g., ethanol).

Polycarbonate polyols include, for example, those obtained from the reaction of diols, such as, for example, 1,3-propanediol, 1,4-butanediol, 1,6-hexanediol, diethylene glycol, triethylene glycol or tetraethylene glycol, with diarylcarbonates (e.g. diphenylcarbonate) or phosgene. Polythioether polyols include, for example, condensation products obtained from thiodiglycol on its own and/or with other glycols, dicarboxylic acids, formaldehyde, aminocarboxylic acids or amino alcohols. The products obtained are either polythio-mixed ethers, polythioether esters or polythioether ester amides. Polyacetals polyols include compounds prepared from aldehydes (e.g. formaldehyde) and glycols, such as diethylene glycol, triethylene glycol, ethoxylated 4,4′-dihydroxy-diphenyldimethylmethane, and 1,6-hexanediol. They may also be prepared by the polymerization of cyclic acetals.

Suitable polyhydroxy polyester amides and polyamines include predominantly linear condensates obtained from polybasic saturated and unsaturated carboxylic acids or their anhydrides and polyvalent saturated or unsaturated amino-alcohols, diamines, polyamines and mixtures thereof.

Monomers for producing polyacrylate polyols include, for example, acrylic acid, methacrylic acid, crotonic acid, maleic anhydride, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, glycidyl acrylate, glycidyl methacrylate, 2-isocyanatoethyl acrylate and 2-isocyanatoethyl methacrylate.

Mixtures of any of the high molecular weight (e.g., having molecular weight of 700-16,000) polyols may be used in preparing the prepolymers for preparing dispersions disclosed herein. In addition, polyurethane prepolymers may be prepared by reacting one or more diisocyanates, one or more high molecular weight polyols, and/or one or more low molecular weight dihydroxyl compounds (e.g., having molecular weight of 50-700). Suitable dihydroxyl compounds include, for example, ethylene glycol, diethylene glycol, 1,2-propanediol, 1,3-propanediol, 1,4-butanediol, 1,3-butylene glycol, neopentyl glycol, butyl ethyl propane diol, cyclohexane diol, 1,4-cyclohexane dimethanol, 1,6-hexanediol, bisphenol A (2,2-bis(4-hydroxyphenyl)propane), hydrogenated bisphenol A (2,2-bis(4-hydroxycyclohexyl)propane), and combinations of any thereof. The dihydroxyl alcohols discussed above in connection with the preparation of polyester polyols or diols and/or polyether polyols, diols or monols which have a relatively low molecular weight are useful in preparing polyurethane prepolymers. Additionally, low molecular weight polyesters, including, for example, esters of adipic acid and ethylene glycol may be used in preparing polyurethane prepolymers. Short-chain homo-addition and co-addition products of ethylene oxide and/or propylene oxide, started on aromatic diols may also be used. Addition products of alkylene oxides, such as, for example, ethylene oxide and/or propylene oxide, with aromatic dihydroxy compounds or aromatic dicarboxylic acids, such as hydroquinone, resorcinol, pyrocatechol or 2,2-bis(4-hydroxyphenyl)propane (bisphenol A) may also be used. Low molecular weight diols may also contain anionic or potentially anionic groups. Low molecular weight diols containing anionic or potentially anionic groups that may be used in the disclosed processes and dispersions include, but are not limited to, dimethylol butanoic acid (DMBA), dimethylol propionic acid (DMBA) and carboxyl-containing caprolactone polyester diol.

Polyurethanes that are used herein may comprise prepolymer segments that may be chain-extended. The polyurethane prepolymer may be chain extended using at least one chain-extending compound comprising hydrazine or aliphatic and/or alicyclic primary and/or secondary diamines, such as, for example, methylenediamine, ethylenediamine, propylenediamine, 1,4-butylenediamine, 1,6-hexamethylenediamine, 2-methyl-1,5-pentanediamine, 1-amino-3,3,5-trimethyl-5-aminomethyl cyclohexane (isophorone diamine), piperazine, 1,4-diaminocyclohexane, bis(4-aminocyclohexyl)methane, adipic acid dihydrazide, and combinations of any thereof.

In addition, polyether diamines, which may be prepared by reaction of the corresponding polyether diols with ammonia and/or primary amines, may be used as a chain-extending compound. These include alkylene oxide diamines, such as, for example, 3-[2-[2-(3-aminopropoxy)ethoxy]ethoxy]propylamine (also known as dipropylamine diethyleneglycol or DPA-DEG), and the other DPA-series ether amines, including, for example, dipropylamine propyleneglycol, dipropylamine dipropyleneglycol, dipropylamine tripropyleneglycol, dipropylamine poly(propylene glycol), dipropylamine ethyleneglycol, dipropylamine poly(ethylene glycol), dipropylamine 1,3-propane diol, dipropylamine 2-methyl-1,3-propane diol, dipropylamine 1,4-butane diol, dipropylamine 1,3-butane diol, dipropylamine 1,6-hexane diol, dipropylamine cyclohexane-1,4-dimethanol, and combinations of any thereof.

The chain-extending compound may comprise an anionic or potentially anionic group and at least two groups which are reactive to isocyanate groups on the prepolymer chain ends. For example, the anionic group or potentially anionic group may comprise a carboxyl group; a carboxylate group; a sulfonic acid group; a sulfonate group or combinations of any thereof. In this regard, carboxyl groups and sulfonic acid groups are potentially ionic groups, whereas, carboxylate groups and sulfonate groups are ionic groups in the form of a salt, such as, for example, a sodium salt.

The at least partial conversion of groups convertible into salt groups of the type mentioned may take place before or after incorporation into the polyurethane backbone. The at least partial conversion of groups convertible into salt groups may also take place before or during the dispersion of the polyurethane in water. In various embodiments, the chain-extending compound may comprise an anionic or potentially anionic group, such as, for example, N-(2-aminoethyl)-2-aminoethane sulfonic acid (AAS); N-(2-aminoethyl)-2-aminopropionic acid; or the sodium salts thereof. In some embodiments, the chain-extending compound may comprise an anionic or potentially anionic group and two (2) amino groups which are reactive to isocyanate groups on the prepolymer chain ends to form urea groups in the polyurethane backbone.

If the free carboxylic acids or sulfonic acids are incorporated in the polyurethane backbone, then the acids may be neutralized with a neutralizing agent, such as, for example, alkali metal hydroxides, alkali metal hydrogen carbonates, alkali metal carbonates or primary amines, secondary amines or tertiary amines, such as, for example, trialkyl-substituted tertiary amines, before dispersion of the polyurethane resin in water. Exemplary amines include, but are not limited to, diisopropyl ethylamine, triisopropanolamine, trimethyl amine, triethyl amine, thisopropyl amine, tributyl amine, N,N-dimethyl-cyclohexyl amine, N,N-dimethylstearyl amine, N,N-dimethylaniline, N-methylmorpholine, N-ethylmorpholine, N-methylpiperazine, N-methylpyrrolidine, N-methylpiperidine, N,N-dimethyl-ethanol amine, N,N-diethyl-ethanol amine, triethanolamine, N-methyldiethanol amine, dimethylaminopropanol, 2-methoxyethyldimethyl amine, N-hydroxyethylpiperazine, 2-(2-dimethylaminoethoxy)-ethanol or 5-diethylamino-2-pentanone. In some cases, suitable tertiary amines include those that do not contain active hydrogen(s) as determined by the Zerewitinoff test since active hydrogen(s) can react with the isocyanate groups of the prepolymer which may cause gelation, the formation of insoluble particles or chain termination.

As previously indicated, the polyurethane dispersion of the present invention can be produced by reacting isocyanate chain ends on the polyurethane to form acylated amines which in turn are converted into methylol groups by a reaction with formaldehyde before, during or after the addition of water.

A way of preparing the polyurethane used in the present invention is first to synthesize a polyurethane with terminal isocyanate groups and an average molecular weight of, for example, less than 20,000, such as 1,000 to 10,000, from the compounds with reactive hydrogen atoms mentioned earlier and a molar excess of polyisocyanates. This may correspond to a free NCO group content of, for example, 0.3 to 20 percent, such as 0.8 to 10 percent or 1.5 to 6 percent. The quantity of isocyanate groups present is then sometime at least 2 per polyurethane molecule. Such prepolymers are obtained in known manner by using an NCO/OH ratio of, for example, between 1.1 and 2.

In embodiments of the present invention, this prepolymer is reacted with a compound containing: (1) at least one group X—NH—R, and (2) at least one group Y which can react with NCO groups. In these embodiments, X can be, for example, —CO—, —CS—, —SO₂—, —NR—CO—, —NR—CS—, —O—CO—, —S—CO—, —O—CS—, —O—SO₂—, —CNR—, —NR—CNR—, —CO—NR—CO—,
CS—NR—CS—,

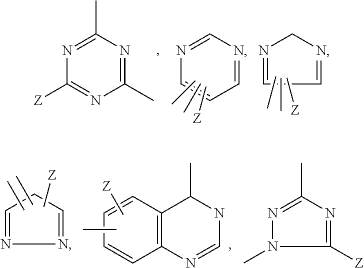

in which Z is —NHR,

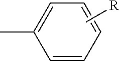

or R, in which R is H or an alkyl radical or alkenyl radical having 1 to 4 carbon atoms and which may also be part of a heterocyclic 5-membered or 6-membered ring with 1 to 3 heteroatoms, and which may be substituted by OH, OCH₃, OC₂H₅, CCl₃, COOH, or SO₃H, or R is ON, CO—R′, SO₂—R′, in which R′ is an alkyl, alkenyl, alkoxy, or carboxyl radical with 1 to 4 carbon atoms; and Y may, for example, be —OH, —NH₂, —NHR₁, —SH, —COOH, —CONH₂, —CSNH₂, —CO—NH—NH₂, NH—CO—NH₂, NH—CS—NH₂ or —NH—NH₂.

Compounds suitable for reaction with the prepolymers which contain NCO groups are at least monofunctional both towards isocyanates and towards formaldehyde and have the general formula Y—X—NHR or Y—R₂—(X—NHR)ₙ wherein X and Y have the meanings indicated above, R₂ is a monovalent or higher valent organic radical, and n is 1-4. R₂ is often an aliphatic, aromatic, cycloaliphatic or araliphatic radical with 1-18 carbon atoms which may also be substituted by alkoxy groups or halogen atoms. It is noted that —X—NHR may be the same as Y, since the carbon-amide or the urea radical may react both with isocyanates and with formaldehyde.

The compounds Y—X—NH—R and Y—R₂—(X—NHR)ₙ include, in addition, aminoplast-forming NH-containing components as defined for example in Angewandte Chemie 76, 909-919 (1964) and described therein (see also A. Bachmann and Th. Bertz.: Aminoplaste, 1967, VEB Deutscher Verlag fur Grundstoffindustrie).

In embodiments of the present invention, the preformed polyurethanes which carry free isocyanate groups react with the compounds Y—X—NHR or Y—R₂—(X—NHR)ₙ and not with chain lengthening to form high molecular weight polyurethanes. In certain embodiments, chain breaking occurs so that the average molecular weight does not exceed, for example, 25,000, and, in some cases, is 2,000 to 10,000. Average molecular weight as described herein can be estimated sufficiently accurately by end group determination of viscosimetric and osmometric molecular weight determination.

In carrying out the reaction when the formaldehyde-containing solutions are subsequently added, one may be able to mix the substance as a solvent free melt, with them mixed thoroughly by means of a usual mixing apparatus. The resulting polyurethane mass which contains terminal X—NHR groups will, in some cases, have a viscosity of less than 1,500 poises, such as 50-1,000 poises, at 120° C.

Although Y—X—NHR or Y—R₂—(X—NHR)ₙ with which the prepolymers are mainly modified are predominantly monofunctional in reaction with isocyanates, they may also be partly incorporated as bifunctional compounds into the polyurethane, though the molecular weight or viscosity desirably do not rise above the desired limits.

Compounds of the formula Y—X—NHR include, for example, the following classes of compounds: ureas, sulphamides, semicarbazides, guanidines, oxamides, biurets, sulphonyl ureas, hydrazodicarbonamides, urethanes, cyanamides, acid amides, cyanuric acid amides, imida-zolidones, tetrahydropyrimidones, hexahydropyrimidones, urones, hexahydro-1,3,5-triazinones and the corresponding thio compounds.

Specific examples of these classes of compounds which are suitable for use in the present invention are, for example, urea, thiourea, sulphamide, semicarbazide, thiosemicarbazide, N-hydroxyurea, guanidine and its salts, methyl urea, ethyl urea, butyl urea, methyl thiourea, allyl thiourea, methyl sulphamide, methyl semicarbazide, methyl thiosemicarbazide, methyl guanidine, oxamide, thiooxamide, biuret, thiobiuret, imino oxamide, dithiooxamide, dithiobiuret, iminothiooxamide, aminosulphonyl urea, hydrazodicarbonamide, thiohydrazodicarbonamide, guanyl urea, aminosulphonyl thiourea, dithiohydrazodicarbonamide, guanyl thiourea, guanidinothiourea, N-aminooxamide, N-aminothiooxamide, hydrazocarboxylic acid ureide, hydrazoearboxylic acid thioureide, iminooxamide hydrazide, guanidino carbohydrazide, N-aminosulphamide, aminoguanidine, methyl-amino guanidine, guanidinourea, N,N-dimethyl urea, N,N-diethyl urea, ethylene urea (imidazolidone), 4,5-dihydroxyimidazolidone, 4,5-di-methoxyimidazolidone, hexahydropyrimidone, melamine, 5-methyl-1,3,5-hexahydrotriazone, 5-ethyl-1,3,5-hexahydrotriazone, 1-oxa-3,5-di-azinone, 4-ureido-6-methyl-hexahydropyrimidone, 4-ureido-5-hydroxyethyl-6-methyl-hexahydropyrimidone and other condensation products of urea with formaldehyde, acetaldehyde or isobutyraldehyde, triacetone diurea, tetrahydropyrimidone, 4,6,6-trimethyl-2-thionotetrahy-dropyrimidone, methyl allophanate, trimethyl biuret, phenyl biuret, benzoyl biuret, amino biuret, cyanogen urea, biguanide, ammeline, thioammeline, carbonyl di-urethane, urea dicarboxylic acid diamide, trimethylol melamine, guanazole, guanazine, dicyandiamide, 1-hydroxy-2,2,2-trichloroethyl urea, N,N-bis(1-hydroxy-2,2,2-trichloroethyl) urea, acetylurea, trichloroacetyl urea, benzoyl urea, triuret, hexahydropyrimidone, acetyl guanidine, trichloroacetyl guanidine, methylsulphonyl urea, ethylsulphonyl urea, phenyl urea, N,N-diphenyl urea, N,N-ditolyl urea, N,N-o-phenylene urea, perinaphthylene urea, ethylene urea, acetylene urea, dimethylacetylene diureine, diphenylacetylene diureine, 2,4-dimethylsemicarbazide, hydroxy-ethylisourea, diphenylguanidine, N-methyl-N-acetyl-guanidine, amino guanidine, anilidoguanidine, N-amino-N-phenyl-guanidine, acetoguanamine, acetoguanide, oxamidic acid, oxalauric acid, thio-oxamidic acid, methylol urea, N,N-bis-methylol urea, hydroxyethyl urea, and N,N-bis-hydroxyethyl urea.

Compounds of the formula Y—R₂—(X—NH—R)ₙ include, without limitation, the specific compounds listed in U.S. Pat. No. 3,756,992 at col. 16, line 60 to col. 18, line 13, the cited portion of which being incorporated herein by reference.

The compounds Y—X—NHR or Y—R₂—(X—NHR)ₙ may either be used in quantities equivalent to the isocyanate groups present or in excess. A ratio of 1.0:1 to 2.5:1, such as 1.0:1 to 1.5:1, is sometimes used.

End groups of the formula —X—NHR can also formed by reacting prepolymers which have terminal NCO groups with ammonia or primary amines, for example with methylamine, ethylamine or ethanolamine. In this case, it may be desirable to introduce the amine component into the reaction vessel and then add the prepolymer. Alternatively, the amine may be converted into the carbonate to reduce the reactivity. The reaction may be carried out in the presence of water.

In some embodiments, R is H, i.e., the compounds in question are acyl derivatives of ammonia.

Some of the compounds listed as anionic modification components are also suitable for use in the reaction with prepolymers which contain isocyanate groups, leading to formation of polyurethanes which carry end groups which are reactive with formaldehyde. These are often compounds which contain at one and the same time a group which is reactive with isocyanate groups, and amide or ureide group and a carboxylic or sulfonic acid group, if desired in salt form. Specific examples of such compounds are listed in U.S. Pat. No. 3,756,992 at col. 18, In. 57 to 19, In. 11, the cited portion of which being incorporated herein by reference.

The total quantity of acylated amino groups —X—NH—R may be greater than that of the end groups themselves because such groups can also be introduced by means of bifunctional chain lengthening agents, alkylating agents or neutralizing agents (acids or bases). In some embodiments, however, the total quantity is 20-120 milliequivalents percent.

By the term “terminal group” is meant a group which depending on the specific —X—NH—R used is linked only at one part to a relatively long radical, while R, in some cases, does not contain more than 4 carbon atoms. In some embodiments, —X—NH—R is a side branch of a main chain or the end group of a side branch. A polyurethane molecule, in some cases, contains on average 1.5 to 10 such terminal groups, such as 2 to 5 such terminal groups.

The introduction into the polyurethane of terminal groups which are reactive with formaldehyde can be carried out at temperatures between room temperature and about 190° C., such as 80° C. to 160° C.

In some embodiments, prepolymers carrying free NCO groups and which contain 0.3 to 20 percent, such as 0.8 to 10 percent, of NCO are reacted with a compound having at least one, such as at least two free reactive methylol groups.

Compounds which carry free methylol groups are, for example, the mono-, di- and oligomethylol compounds of the compounds Y—X—NHR or Y—R₂—(X—NHR)ₙ as described above, methylol compounds of aliphatic and araliphatic ketones, nitriles or 3-ketocarboxylic acid esters, compounds which have CH acidic hydrogen atoms, as well as of phenols, di- and polycarboxylic acid amides and di- and oligourethanes, provided that such compounds have at least one free methylol group left after the reaction with the isocyanate groups present.

The following are examples of suitable methylol compounds: dimethylol urea, tetramethylol urea, trimethylol melamine, tetramethylol melamine, pentamethylolmelamine, hexamethylolmelamine, tetramethylol hydrazodicarbonamide, dimethylol dicyandiamide, pentamethylol-4-ureido-6-methyl-hexahydropyrimidone, dimethylol-p-cresol, tetramethylolacetone, hexamethylol acetone, tetramethylol methylethylketone, pentamethylol methylethyl ketone, tetramethylol hexanone and dimethylolthiourea. In addition, methylol compounds of such compounds already mentioned which carry end groups which are reactive with formaldehyde may be used.

Methylol-containing condensation products of urea formaldehyde, urea acetaldehyde-formaldehyde, urea furfurolformaldehyde, urea crotonaldehyde-formaldehyde and melamine formaldehyde may also be used. In general, many different methylol-containing phenol formaldehyde or amine formaldehyde condensation products such as those commonly described as phenol resins or amine resins and which are produced commercially may be used. Xylene-formaldehyde resins which contain methylol groups may also be used.

Low molecular weight polymers and copolymers based on acrylamide or methacrylamide and formaldehyde may also be used.

Any of the methylol compounds of di- and oligourethanes, such as those formed from polyisocyanates and alcohols, from polyisocyanates and polyalcohols or from monoisocyanates and polyalcohols, may be used. Examples are methylol compounds of the adducts of: 1,6-hexane diisocyanate and methanol, ethanol or propanol; 2,4-toluylene-diisocyanate, trimethylol propane, and methanol; triphenylmethane triisocyanate and methanol; pentaerythritol and methylisocyanate; and trimethylol propane and methoxymethyl isocyanate.

The methylol-containing substance which is used is often nonionic and is then reacted with an NCO prepolymer which itself has a (potentially) anionic character.

Alternatively, one may start with prepolymers free from anionic groups or potential ionic groups and react these prepolymers with methylol compounds which carry (potentially) anionic groups, such as carboxyl or sulfonic acid groups or their salts.

The methylol compounds may be used in quantities equivalent to the NCO groups present, i.e., one mol of methylol compounds to one NCO equivalent, but they also may be used in excess, such as in an equivalent ratio of 1.0 to 2.5:1 or 1.0 to 1.5:1.

The polyurethanes may contain a certain proportion of methylol groups in addition to acylated amino groups —X—NHR which are reactive with formaldehyde. An amount of, on average, about one reactive methylol group per molecule is often sufficient for subsequent chain lengthening if desired.

The reaction of the starting components to convert them into (potential) polyurethanes, in particular the last stage, of the process (reaction of the NCO prepolymer with compounds Y—X—NHR or Y—R₂—(X—NHR)ₙ or their methylol compounds) can be promoted by the addition of solvents such as dimethyl formamide, diethyl formamide, ethylene glycol, diethylene glycol and their ethers and esters. The quantity of solvent introduced is often not more than about 6 percent of the total amount of polyurethane dispersion. The use of solvents with hydroxyl groups which are later built into the polyurethane under the action of the formaldehyde may be advantageous.

In some embodiments, the process is carried out without organic solvent. In such cases, the dispersions formed do not have to be subjected to a distillation process and do not require any special precautions on account of the presence of residual quantities of solvent. One may, of course, use water as solvent.

The absence of organic solvents in the process can be possible because low molecular weight polyurethanes which are free from NCO groups are dispersed by mixing with water. In such cases, a chain lengthening reaction occurs only during, or some times after, dispersion, being brought about by heat treatment and if desired by lowering of the pH. This reaction may lead either to the formation of a thermoplastic resin or to the formation of a high molecular weight resin which may be cross-linked. This chain lengthening reaction to form the high molecular weight polymer takes place without substantial increase of viscosity in the aqueous binary system.

Polyurethanes containing groups reactive with formaldehyde are converted with formaldehyde-containing solutions into methylol-containing anionic polyurethanes during or immediately before dispersion to, in some cases, have an average molecular weight of less than 25,000, such as 2,000 to 10,000 or 3,000 to 8,000. As previously indicated, the average molecular weight can be estimated with sufficient accuracy by group determination and osmometric measurements. In many cases the approximate average molecular weight can be determined from the stoichemistry of the reactants employed for the synthesis of the polyurethane. The calculated molecular weight is sometimes below 10,000, such as below 8,000. In some cases, the viscosity at 120° C. is less than 1500 poises, such as 50 to 1,000 poises.

In some embodiments, the polyurethane which contains terminal groups which are reactive with formaldehyde has a salt group content of 4-120 milliequivalents percent. This means that for an average molecular weight of 2,500 at least every tenth molecule incorporated carries a salt group. These portions of the polyurethanes which carry salt groups then act as emulsifiers for the non-ionic portions. Anionic salt groups of various types of chemical constitution may be used, such as, without limitation, COO—, —SO³⁽⁻⁾, —O—SO₃⁽⁻⁾, and/or SO₂⁽⁻⁾. The same applies to polyurethanes which carry methylol groups.

The polyurethanes need not be present in the salt form before addition of the aqueous solution which contains formaldehyde. Instead, these groups may be present in a potential form, i.e., as groups which are capable of salt formation. This may be desirable if salt formation takes place by neutralization in the presence of water.

It may be desirable that the (potential) anionic polyurethanes have hydrophobic chain segments. By “hydrophobic chain segments” are meant segments containing neither salt groups nor groups capable of salt formation which are converted into salt groups in the course of the process. These hydrophobic segments may, for example, be polyether, polyester, polythioether or polyacetal segments which may also be interrupted by longer hydrocarbon radicals or urethane or urea groups. Those polyurethanes in which these hydrophobic segments consist of 250-400 chain members and only contain small number (e.g. 4-10) urethane or urea groups, may be used.

In certain embodiments, water is first added to the polyurethane mass until it appears cloudy. This quantity of water may contain the quantities of bases required for neutralization of acid groups. This first quantity of water may amount to about one tenth to one quarter of the weight of the polyurethane mass. The temperature is, in some cases, 50 to 100° C. Aqueous formaldehyde may then be added within the same temperature range, followed by water. During the addition of water, the temperature may be about 150° C. If desired, this operation may be carried out under pressure.

The necessary quantity of formaldehyde may also be dissolved in the total amount of water required for dispersion, and this solution may be added gradually.

Alternatively, a concentrated solution or suspension containing formaldehyde may first be added to the polyurethane melt (e.g. a suspension of paraformaldehyde in a little water), and the resulting polyurethane mass may then be dispersed by admixture of water. Paraformaldehyde or compounds which give off formaldehyde may also be added in succession to the reaction mass, in which case an aqueous solution which contains formaldehyde is formed in situ.

It is also possible to pre-disperse the anionic polyurethane having terminal reactive acylated amino groups with water and to add, in the last reaction step, formaldehyde in free or dissolved or chemically bonded form. In such cases at least some portion of the water added may contain formaldehyde.

Instead of free formaldehyde, aqueous solutions of substances which give off formaldehyde, such as solutions of paraformaldehyde, trioxane, methylal, hexamethylene tetramine, oligomethylol compounds, such as di- and oligomethylol ureas, -hexahydropyrimidinones, -urones, -melamines and other triazine derivatives may be used. Methylol ethers may be used, such as when used together with acid catalysts and therefore exist partly as free methylol compounds or free formaldehyde.

The following are examples of methylol compound which may be used: dimethylol urea, hexamethylol melamine, hexamethylol-melamine methyl ether, tetramethylol acetone, hexamethylol acetone, methylol compounds and methylol ethers of urea, ethylene urea, methylene diurea, biuret, carbonyldiurea, hexamethylene diurea, acetylene diurea, hydrazodicarbonamide, tetrahydropyrimidinone, tetrahydro-1,3,5-oxadiazinone-(4), dicyandiamide, acrylamide polymers and methacrylamide polymers, formaguanamine, acetoguanamine and benzogua amine.

In addition to formaldehyde, higher aldehydes such acetaldehyde, chloral, crotonaldehyde, acrolein, furfur, glyoxal and glutaric dialdehyde, ketones such as acetone, methylethyl ketone and cyclohexanone, and their condensates with compounds which form aminoplasts or mixed condensates with formaldehyde and compounds which form aminoplasts, may be used.

So that reaction with the reactive groups —X—NHR occurs, the aqueous solution of such formaldehyde derivatives often contain free formaldehyde in equilibrium under the reaction conditions. It is not necessary, however, for this reaction to produce exclusively the methylol-containing groups. It is possible for new methylol components to be produced by reaction of the reactive group —X—NHR with oligomethylol compounds HO—CH₂—Z—(CH₂—OH)ₙ in which Z is, for example, a radical which is difunctional to hexafunctional towards formaldehyde and n is an integer from 1-5. Reference is made herein to U.S. Pat. No. 3,756,992 at col, 25, In. 19-42, the cited portion of which being incorporated by reference.

Further condensation in which the methylol compounds undergo substantially complete reaction can be avoided before formation of the dispersion by carrying out the mixing of the polyurethane with the formaldehyde containing aqueous solutions at pH values of, for example, between 9 and 4.1, such as 7.5 to 5. Furthermore, the stages between the mixing process and the formation of the dispersion often generally not take longer than about two hours.

The quantity of formaldehyde required, in free bound form, depends on the quantity of reactive —X—NHR groups present, taking into account all the reactive —X—NHR groups present within the chain. The equivalent ratio of —X—NHR to formaldehyde (based on the free formaldehyde) is often from 1:0.3 to 1:4 or 1:2 to 1:0.6.

Catalysts such as sodium carbonate, potassium carbonate, ammonia or urotropine may be added to accelerate the reaction between the terminal acylated amino groups and the dissolved formaldehyde. The quantity of water used can depend mainly on the concentration at which the paste of water in polyurethane is first formed is changed over into a polyurethane/water dispersion. While this may occur at polyurethane at concentrations of about 68 percent, in some cases it may not occur until the concentration is 20 percent. The total quantity of water required thus often amounts to 0.5 to 4 times, such as 0.8 to 3 times, the quantity of polyurethane. The water should be added at such a rate that it will be taken up evenly by the polyurethane mass. The mixing process may generally be carried out satisfactorily in the usual stirrer apparatus or stirring tanks with slowly rotating horseshoe stirrers, provided that the stirring is sufficiently efficient for the high viscosities which occur.

If the polyurethane mass already contains terminal methylol groups, for example due to reaction of a pre-polymer which carries NCO end groups with oligomethylol compounds, the presence of formaldehyde during the dispersing process is not necessary. In such cases, water, if desired together with the quantities of bases for neutralization of potential salt groups, is stirred into the (potential) anionic polyurethane which contains terminal reactive methylol groups. The spontaneous dispersion of the polyurethane which then takes place is brought about by the combined action of the built-in ionic groups and the terminal methylol groups.

In general, the water is first taken up with formation of an almost clear solution. With progressive addition of water, a milky white paste may be formed which contains the water partly in solution and partly dispersed in the polyurethane (water-in-oil type of dispersion). With further the addition of water, the paste changes to a polyurethane in water dispersion. In some cases, this transition takes place on cooling the dispersion. The temperature during the addition of water is often from room temperature to 150° C. or 50° C. to 130° C. One may, for example, stir in approximately the first half of the water at a temperature of 80° C. to 130° C. and then add more water with cooling. According to one procedure, the total quantity of water up to formation of the polyurethane-in-water dispersion is added at temperatures of about 100° C. At temperatures above 130° C., it may be advantageous to work under excess pressure.

One specific example of an aqueous anionic, aliphatic polyurethane dispersion comprising a polyurethane having terminal methylol groups, which is suitable for use in the present invention, is IMPRANIL® 43032 (an anionic, aliphatic, polyetherurethane dispersion with a solids content of about 30%), from Bayer MaterialScience LLC. Suitable methods for making such an aqueous anionic, aliphatic polyurethane dispersion are generally described in U.S. Pat. No. 3,756,992 at col. 3, In. 8 to col. 26, In. 56, the cited portion of which being incorporated herein by reference.

As indicated earlier, the methods of the present invention comprise mixing an aqueous anionic, aliphatic polyurethane dispersion comprising a polyurethane having terminal methylol groups, as described above, with a second component comprising an aqueous anionic acrylic polymer solution having a viscosity of 25,000 to 60,000 mPa·s at 20° C. when measured according to DIN EN ISO 3219 at a non-volatile content of 9% to 11% by weight, based on the total weight of the solution, measured according to DIN 53189. Such as aqueous anionic acrylic polymer solution is commercially available as Borchi® Gel A LA, from OMG Borchers GmbH.

It has been discovered, surprisingly, that by proper combination of the previously described polyurethane dispersion and an aqueous anionic acrylic polymer solution of the type described above, in the correct amount, and by employing a specific procedure of preparing and applying the mixture to a substrate, it is possible to provide a low gloss coating (60° gloss of 35 or less, 30 or less, 25 or less, 20 or less, 15 or less, such as 14 or less, 13 or less, 12 or less, 11 or less, 10 or less, 9 or less, or 8 or less) with an optically uniform appearance (as described above) without the use of flatting agents or with a significantly reduced amount of flatting agent as compared to what is typically required to achieve low gloss or very low gloss coatings. As a result, it is currently believed that extremely low gloss coatings, i.e., coating exhibiting a 60° gloss of 6, 5, 4, 3 or 2 or less gloss units, can be obtained by using much less flatting agent than has previously been necessary. As a result, it is expected that the physical and chemical properties of the coating would not be as severely impacted as in cases in which significantly larger amounts of flatting agents are used to obtain such extremely low gloss coatings.

Certain criticalities have been observed to obtain the results described above. For example, it has been observed that the acrylic polymer solution should be included in the coating composition in an amount such that the acrylic polymer that is in the solution is present in an amount of 0.2 to 1 percent by weight, such as 0.3 to 0.9 percent by weight, or, in some cases, 0.4 to 0.7 percent by weight, based on the weight of resin solids of the previously described aqueous anionic, aliphatic polyurethane dispersion comprising a polyurethane having terminal methylol groups.

It has also been observed that a two-component composition (as defined above) should be used in the methods of the present invention. It has been observed that when such a two-component composition is not used, then the resulting film has not exhibited a low gloss and/or does not have an optically uniform appearance.

It has also been observed that the desirable results are achieved when the overall solids content of the resulting composition that is applied to the substrate is less than 50%, such as no more than 45% or, in some cases, no more than 40% by weight, based on the total weight of the composition.

As used herein, the phrase “without the substantial use of flatting agents” means that the mixture is substantially or completely free of conventional matting (or flatting) agents. The term “matting agent” or “flatting agent” as used herein, refer to fine particle powders of organic and inorganic materials that have a particle size of about 1 to 20 microns and are made of, for example, silica, silicate, polymeric beads, talc, alumina, calcium carbonate, calcium stearate, zinc stearate, aluminum rosinate, and/or clay. As used herein, “substantially free” means that the flatting agent is present in the mixture that is applied to the substrate, if at all, in an amount of less than 1 percent by weight, less than 0.5 percent by weight, less than 0.2 percent by weight, or, in some cases, less than 0.1 percent by weight, based on the total weight of the mixture.

In certain embodiments, in order to obtain a film exhibiting an extremely low gloss, i.e., a 60° gloss of 6 or less, 5 or less, 4 or less, 3 or less, or 2 or less gloss units, it may be necessary to include some flatting agent. However, it is currently believed that the amount of flatting agent needed to achieve such an extremely low gloss film is relatively small. For example, it is currently believed that such extremely low gloss films can be achieved by including a flatting agent in the composition that is applied to the substrate in an amount of no more than 8 percent by weight, such as no more than 7, no more than 6 or, in some cases, no more than 5 percent by weight, based on the total weight of the mixture that is applied to the substrate. In some of these embodiments, the flatting agent is present in an amount of at least 1 percent by weight, such as at least 2 percent by weight, at least 3 percent by weight, or, in some cases, at least 4 percent by weight, based on the total weight of mixture that is applied to the substrate.

In certain embodiments of the present invention, in order to modify the properties of the resulting film, it may be desirable if the mixture comprises a second aqueous anionic polyurethane dispersion different from the polyurethane having terminal methylol groups described above. Such aqueous anionic polyurethane dispersions can comprise, for example, polyether-polyurethanes, polyester-polyurethanes, polyacrylic-polyurethanes, or polycarbonate-polyurethanes, depending upon the desired properties to be incorporated into the resultant product. Suitable such aqueous anionic polyurethane dispersions are commercially available as, for example, IMPRANIL® DLC-F (an anionic polycarbonate ester polyurethane dispersion in water), IMPRANIL® DL 1554 (an anionic aliphatic polyester-polyurethane dispersion); DISPERCOLL® U XP 2643 (aqueous dispersion of an anionically modified polyurethane); DISPERCOLL® U XP 2699 (polyurethane dispersion); Impranil® LP DSB 1069 (anionic, aliphatic polyether-polyurethane); and Bayhydrol® AH XP 2741 (aqueous core-shell styrene acrylate dispersion), each from Bayer MaterialScience LLC.

It has been surprisingly discovered, however, that the manner in which such second aqueous anionic polyurethane dispersion is incorporated into the composition is important in order to maintain the ability to provide a resulting film that exhibits a very low gloss, i.e., 60° gloss of 20 or below, such as 15 or below, in combination with an optically uniform appearance, as is desired.

In particular, it has been discovered, surprisingly, that inclusion of the second aqueous anionic polyurethane dispersion into the composition after a base composition comprising a mixture comprising: (1) a first aqueous anionic, aliphatic polyurethane dispersion comprising a polyurethane having terminal methylol groups; and (2) the second component comprises an aqueous anionic acrylic polymer solution having a viscosity of 25,000 to 60,000 mPa·s at 20° C. measured according to DIN EN ISO 3219 at a non-volatile content of 9% to 11%, based on total weight of the solution, measured according to DIN 53189, is provided wherein (2) is dispersed in (1), provides the desirable low gloss coatings. Moreover, the second aqueous anionic polyurethane dispersion may be added in any amount so long as the overall solids content of the resulting composition is less than 50% by weight, such as no more than 45% by weight or, in some cases, no more than 40% by weight, based on the total weight of the composition. If desired, more water may be added to the composition in order to obtain the desired solids content for application. It has been observed that if the foregoing procedure is not followed, low gloss coatings are not obtained.

As a result, the present invention is also directed to methods for making an aqueous polyurethane dispersion. These methods comprise: (a) mixing a first component and a second component to make a mixture thereof, wherein: (1) the first component comprises a first aqueous anionic, aliphatic polyurethane dispersion comprising a polyurethane having terminal methylol groups; and (2) the second component comprises an aqueous anionic acrylic polymer solution having a viscosity of 25,000 to 60,000 mPa·s at 20° C. measured according to DIN EN ISO 3219 at a non-volatile content of 9% to 11%, based on the total weight of the solution, measured according to DIN 53189, for a time and under conditions so as to disperse (2) in the mixture; and (b) adding a second aqueous polyurethane dispersion, different from (1), to the mixture of step (a) such that the resin solids content of the aqueous polyurethane dispersion is less than 50% by weight, such as no more than 45% by weight or no more than 40% by weight, based on the total weight of the aqueous polyurethane dispersion.

In some embodiments, the compositions described herein comprise any of a variety of optional ingredients, such as fillers, plasticizers, crosslinking agents, resins, colorants (such as pigments), light stabilizers, optical-brighteners, thixotropic agents, among others. Certain compositions are free of one or more of such ingredients.

The compositions described herein can be applied to a substrate by any of the variety of methods, such as spray coating, brush coating, dip coating, transfer coating, direct coating, among other techniques. Dry film thickness can range within any desired range, such as 0.1 to 5 mils. Cured coatings deposited according to the methods of the present invention have been observed to exhibit an average deviation surface roughness of at least 100 nm, such as at least 150 nm or, in some cases at least 190 nm and/or a root mean square surface roughness of at least 200 nm, or, in some cases at least 250 nm. For purposes of the present invention, average deviation surface roughness and root mean square surface roughness are determined using Bruker Instruments' Dimension 3100 Atomic force Microscope equipped with the NanoScope® 111 A control station, a Dimension AFM scan head and the Quadrex electronic module, and using the tapping mode as the imaging mode of operation. Height images, using 80-μm scans at scan rates of 0.59 Hz and with a resolution of 512 sample points per line scan are used for measuring the surface roughness parameters (Ra and Rq (RMS)) of the coatings. The roughness values are calculated using the AFM's version 5.31R1 software package. All reported roughness parameter values are averages of at least three measurements carried out at different locations of the coating's surface.

As will be appreciated by the foregoing description, embodiments of the present invention are directed to methods for coating a substrate, comprising depositing a two-component coating composition comprising a first component and a second component over the substrate to form a film having a 60° gloss of no more than 35 gloss units measured according to ASTM D523-89, wherein: (i) the first component comprises an aqueous anionic, aliphatic polyurethane dispersion comprising a polyurethane having terminal methylol groups; and (ii) the second component comprises an aqueous anionic acrylic polymer solution having a viscosity of 25,000 to 60,000 mPa·s at 20° C. when measured according to DIN EN ISO 3219 at a non-volatile content of 9% to 11% by weight, based on the total weight of the solution, measured according to DIN 53189.

Embodiments of the present invention are also directed to a method of the preceding paragraph, wherein the substrate is at least partially constructed of metal, plastic, ceramic, glass, or a natural material.

Some embodiments of the present invention are directed to a method of any of the preceding two paragraphs wherein the film forms a topcoat.

In some embodiments, the present invention is directed to a method of any of the preceding three paragraphs, wherein the substrate comprises a textile, such as synthetic leather.

In certain embodiments, the present invention is directed to a method of any of the preceding four paragraphs, wherein the substrate comprises a part of furniture, an article of clothing, a shoe, or a vehicle seat.

Some embodiments of the present invention are directed to a method of any of the preceding five paragraphs, wherein the film has a 60° gloss of no more than 35 gloss units, no more than 30 gloss units, no more than 25 gloss units, no more than 20 gloss units, no more than 15 gloss units, no more than 14 gloss units, no more than 13 gloss units, no more than 12 gloss units, no more than 11 gloss units, no more than 10 gloss units, no more than 5 gloss units, no more than 4 gloss units, no more than 3 gloss units, or no more than 2 gloss units.

Embodiments of the present invention are directed to a method of any of the preceding six paragraphs, wherein the anionic, aliphatic polyurethane dispersion comprises a polyether-polyurethane dispersion comprising sulfonate groups.

Some embodiments of the present invention are directed to a method of any of the preceding seven paragraphs, wherein the polyurethane having terminal methylol groups is a reaction product of a hydrophilically modified acylated amine functional polyurethane prepolymer and formaldehyde, such as where the hydrophilically modified acylated amine functional polyurethane prepolymer has acylated amino groups of the formula: —X—NHR, wherein X is —CO—, —CS—, —SO₂—, —NR—CO—, —NR—CS—, —O—CO—, —S—CO—, —O—CS—, —O—SO₂—, —CNR—, —NR—CNR—, —CO—NR—CO—, —CS—NR—CS—,

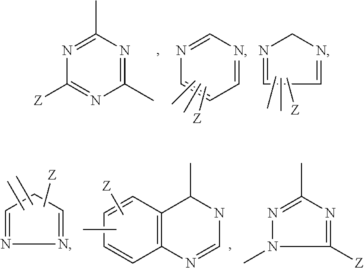

in which Z is —NHR,

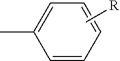

or R, in which R is H or an alkyl radical or alkenyl radical having 1 to 4 carbon atoms and which may also be part of a heterocyclic 5-membered or 6-membered ring with 1 to 3 heteroatoms, and which may be substituted by OH, OCH₃, OC₂H₅, CCl₃, COOH, or SO₃H, or R is CN, CO—R′, SO₂—R′, in which R′ is an alkyl, alkenyl, alkoxy, or carboxyl radical with 1 to 4 carbon atoms; and Y may, for example, be —OH, —NH₂, —NHR₁, —SH, —COOH, —CONH₂, —CSNH₂, —CO—NH—NH₂, NH—CO—NH₂, NH—CS—NH₂ or —NH—NH₂ in which R is H or an alkyl radical or alkenyl radical having 1 to 4 carbon atoms and which may also be part of a heterocyclic 5-membered or 6-membered ring with 1 to 3 heteroatoms, and which may be substituted by OH, OCH₃, OC₂H₅, CCl₃, COOH, or SO₃H, or R is CN, CO—R′, SO₂—R′, in which R′ is an alkyl, alkenyl, alkoxy, or carboxyl radical with 1 to 4 carbon atoms; and Y may, for example, be —OH, —NH₂, —NHR₁, —SH, —COOH, —CONH₂,
CSNH₂, —CO—NH—NH₂, NH—CO—NH₂, NH—CS—NH₂ or —NH—NH₂, such as where the acylated amino groups are of the formula: —NH—CO—NH₂.

In certain embodiments, the solids content of the mixture that is applied to the substrate in a method of any of the previous eight paragraphs, is less than 50% by weight, such as no more than 45% by weight, or no more than 40% by weight.

Embodiments of the present invention are also directed to a method of any of the previous nine paragraphs, wherein (ii) is present in the coating composition in an amount such that the acrylic polymer that is in the solution is present in an amount of 0.2 to 1 percent by weight, such as 0.3 to 0.9, 0.4 to 0.7 percent by weight, based on the weight of resin solids in (i).

In some embodiments, the present invention is directed to a method of any of the previous ten paragraphs, wherein the coating composition comprises (iii) an aqueous anionic, aliphatic polyurethane dispersion different from (ii), such as a polyether-polyurethane, a polyester-polyurethane, a polyacrylic-polyurethane, and/or a polycarbonate-polyurethane.

Embodiments of the present invention are also directed to a method of any of the previous eleven paragraphs wherein the mixture is applied to the substrate to form a film within 2 hours, such as within 1 hour, after the mixture has been prepared.

In some embodiments, the present invention is directed to a method of any of the previous twelve paragraphs, wherein the mixture further comprises a flatting agent present in an amount of no more than 5 percent by weight, such as 0.1 to 5 percent by weight, 1 to 5 percent by weight, 2 to 5 percent by weight, 3 to 5 percent by weight, or, in some cases, 4 to 5 percent by weight, based on the total weight of mixture that is applied to the substrate, and the film has a 60° gloss is no more than 6 gloss units, 5 gloss units, such as a 60° gloss of 4 or less, 3 or less, or 2 or less gloss units.

Some embodiments of the present invention are directed to a substrate coated according to a method of any of the previous thirteen paragraphs.

As will also be appreciated from the foregoing description, the present invention is also directed to a method comprising: (a) mixing a first component and a second component to make a mixture thereof, wherein: (1) the first component comprises a first aqueous anionic, aliphatic polyurethane dispersion comprising a condensation reaction product of a polyurethane prepolymer having terminal methylol groups; and (2) the second component comprises an aqueous anionic acrylic polymer solution having a viscosity of 25,000 to 60,000 mPa·s at 20° C. measured according to DIN EN ISO 3219 at a non-volatile content of 9% to 11%, based on the total weight of the solution, measured according to DIN 53189, for a time and under conditions so as to disperse (2) in the mixture; and (b) adding a second aqueous polyurethane dispersion, different from (1), to the mixture of step (a) such that the resin solids content of the aqueous polyurethane dispersion is less than 50% by weight, such as no more than 45% by weight, or no more than 40% by weight, based on the total weight of the aqueous polyurethane dispersion.

In some embodiments, the present invention is directed to a method of the previous paragraph wherein the anionic, aliphatic polyurethane dispersion comprises a polyether-polyurethane dispersion comprising sultanate groups.

Certain embodiments of the present invention are directed to a method of any of the previous two paragraphs wherein the polyurethane having terminal methylol groups is a reaction product of a hydrophilically modified acylated amine functional polyurethane prepolymer and formaldehyde, such as where the hydrophilically modified acylated amine functional polyurethane prepolymer has acylated amino groups of the formula: —X—NHR, wherein X is —CO—, —CS—, —SO₂—, —NR—CS—, —O—CO—, —S—CO—, —O—CS—, —O—SO₂—, —CNR—, —NR—CNR—, —CO—NR—CO—, —CS—NR—CS—,

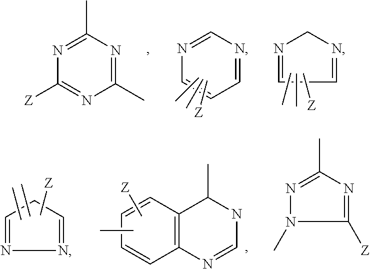

in which Z is —NHR,

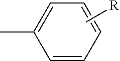

or R, in which R is H or an alkyl radical or alkenyl radical having 1 to 4 carbon atoms and which may also be part of a heterocyclic 5-membered or 6-membered ring with 1 to 3 heteroatoms, and which may be substituted by OH, OCH₃, OC₂H₅, CCl₃, COOH, or SO₃H, or R is CN, CO—R′, SO₂—R′, in which R′ is an alkyl, alkenyl, alkoxy, or carboxyl radical with 1 to 4 carbon atoms; and Y may, for example, be —OH, —NH₂, —NHR₁, —SH, —COOH, —CONH₂, —CSNH₂, —CO—NH—NH₂, NH—CO—NH₂, NH—CS—NH₂ or —NH—NH₂, such as where the acylated amino groups are of the formula: —NH—CO—NH₂.

Embodiments of the present invention are also directed to a method of any of the previous three paragraphs wherein (2) is present in the coating composition in an amount such that the acrylic polymer that is in the solution is present in an amount of 0.2 to 1 percent by weight, such as 0.3 to 0.9, 0.4 to 0.7 percent by weight, based on the weight of resin solids in (1)

In some embodiments, the present invention is directed to a method of any of the previous four paragraphs, wherein (b) comprises a polyether-polyurethane, a polyester-polyurethane, a polyacrylic-polyurethane, and/or a polycarbonate-polyurethane.

In certain embodiments, the present invention is directed to a method of any of the previous five paragraphs, further comprising depositing the dispersion over a substrate to form a film having a 60° gloss of no more than 35 gloss units, no more than 30 gloss units, no more than 25 gloss units, no more than 20 gloss units, no more than 15 gloss units, no more than 14 gloss units, no more than 13 gloss units, no more than 12 gloss units, no more than 11 gloss units, no more than 10 gloss units, no more than 6 gloss units, no more than 5 gloss units, no more than 4 gloss units, no more than 3 gloss units, or no more than 2 gloss units, measured according to ASTM D523-89.

In some embodiments, the present invention is directed to a method of the previous paragraph, wherein the mixture is applied to the substrate to form a film within 2 hours, such as within 1 hour, after the mixture has been prepared.

In embodiments, the present invention is directed to a method of any of the previous two paragraphs, wherein the mixture further comprises a flatting agent present in an amount of no more than 5 percent by weight, such as 0.1 to 5 percent by weight, 1 to 5 percent by weight, 2 to 5 percent by weight, 3 to 5 percent by weight, or, in some cases, 4 to 5 percent by weight, based on the total weight of mixture that is applied to the substrate, and the film has a 60° gloss is no more than 5 gloss units, such as a 60° gloss of 4 or less, 3 or less, or 2 or less gloss units.

Some embodiments of the present invention are directed to a method of any of the previous three paragraphs wherein the substrate is at least partially constructed of metal, plastic, ceramic, glass, or a natural material.

Embodiments of the present invention are also directed to a method of any of the preceding four paragraphs wherein the film forms a topcoat.

In some embodiments, the present invention is directed to a method of any of the preceding five paragraphs, wherein the substrate comprises a textile, such as synthetic leather.

Embodiments of the present invention are also directed to a method of any of the preceding six paragraphs, wherein the substrate comprises a part of furniture, an article of clothing, a shoe, or a vehicle seat.

As will further be appreciated by the foregoing description, embodiments of the present invention are directed to methods for coating a substrate, comprising depositing a two-component coating composition comprising a first component and a second component to make a mixture thereof over the substrate within 2 hours after the mixture has been prepared to form a film having a 60° gloss of no more than 35 gloss units measured according to ASTM D523-89, wherein: (i) the first component comprises an aqueous anionic, aliphatic polyether-polyurethane dispersion comprising a polyurethane having terminal methylol groups and sulfonate groups and comprising a reaction product of a hydrophilically modified acylated amine functional polyurethane prepolymer and formaldehyde; (ii) the second component comprises an aqueous anionic acrylic polymer solution having a viscosity of 25,000 to 60,000 mPa·s at 20° C. when measured according to DIN EN ISO 3219 at a non-volatile content of 9% to 11% by weight, based on the total weight of the solution, measured according to DIN 531899, wherein (ii) is present in the coating composition in an amount such that the acrylic polymer that is in the solution is present in an amount of 0.2 to 1 percent by weight, based on the weight of resins solids in (I); and (iii) the resin solids content of the mixture is less than 50% by weight, based on the total weight of the coating composition.

Some embodiments of the present invention are directed to a method of the previous paragraph, in which the substrate comprises a textile, such as synthetic leather.

In certain embodiments, the present invention is directed to a method of any of the previous two paragraphs, wherein the hydrophilically modified acylated amine functional polyurethane prepolymer has acylated amino groups of the formula: —X—NHR, wherein X is —CO—, —CS—, —SO₂—, —NR—CO—, —NRm-CS—, —O—CO—, —S—CO—, —O—CS—, —O—SO₂—, —CNR—, —NR—CNR—, —CO—NR—CO—, —CS—NR—CS—,

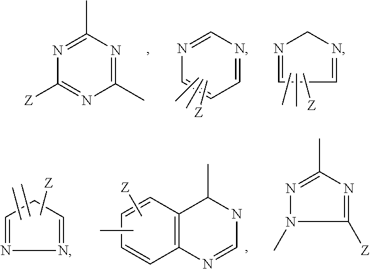

in which Z is —NHR,

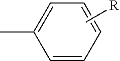

or R, in which R is H or an alkyl radical or alkenyl radical having 1 to 4 carbon atoms and which may also be part of a heterocyclic 5-membered or 6-membered ring with 1 to 3 heteroatoms, and which may be substituted by OH, OCH₃, OC₂H₅, CCl₃, COOH, or SO₃H, or R is CN, CO—R′, SO₂—R′, in which R′ is an alkyl, alkenyl, alkoxy, or carboxyl radical with 1 to 4 carbon atoms, such as where the acylated amino groups are of the formula: —NH—CO—NH₂.

Embodiments of the present invention are also directed to a method of any of the previous three paragraphs, in which (ii) is present in the coating composition in an amount such that the acrylic polymer that is in the solution is present in an amount of 0.3 to 0.9, such as 0.4 to 0.7 percent by weight, based on the weight of resin solids in (i).

In some embodiments, the present invention is directed to a method of any of the previous four paragraphs, in which the coating composition comprises an aqueous anionic, aliphatic polyurethane dispersion different from (ii), which comprises a polyester-polyurethane, a polyether-polyurethane, a polyacrylic-polyurethane and/or a polycarbonate-polyurethane.

Some embodiments of the present invention comprise a method of any of the previous five paragraph, in which the mixture further comprises a flatting agent present in an amount of no more than 5 percent by weight, such as 0.1 to 5 percent by weight, 1 to 5 percent by weight, 2 to 5 percent by weight, 3 to 5 percent by weight, or, in some cases, 4 to 5 percent by weight, based on the total weight of mixture that is applied to the substrate, and the film has a 60° gloss is no more than 5 gloss units, such as a 60° gloss of 4 or less, 3 or less, or 2 or less gloss units in an amount of no more than 5 percent by weight, based on the total weight of the mixture, and the 60° gloss is no more than 8 gloss units.

In some embodiments, the present invention is directed to a method of any of the previous six paragraphs, wherein the resin solids content of the mixture is no more than 45% by weight, based on the total weight of the aqueous polyurethane dispersion.

Illustrating the invention are the following examples that do not limit the invention to their details. All parts and percentages in the examples, as well as throughout the specification, are by weight unless otherwise indicated.

### EXAMPLES

### Example 1

Various compositions (1A-1E) were prepared by mixing the ingredients and amounts (in grams) listed in Table 1 using a mixing blade on a IKA Labortechnik Eurostar power control-visc under a shear rate of 500-600 minute⁻¹ until evenly distributed. Within 30 minutes after mixing, each formulation was then drawn down onto an unpolished B-952 metal panel using a 5 mil bar, and then allowed to flash for 5 minutes, then baked at 90° C. for 5 minutes. After cooling, the coating was evaluated for 60° gloss. Results are set forth in Table 1.

TABLE 1

| Ingredient | 1A | 1B | 1C | 1D | 1E |
|---|---|---|---|---|---|
| IMPRANIL ® 43032¹ | 75 | 75 | 75 | 75 | 75 |
| Borchi ® Gel A LA² | 0.5 | 1 | 1.5 | 2 | 3 |
| % A LA | 0.7% | 1.3% | 2.0% | 2.7% | 4.0% |

Test Results

| | | | | | |
|---|---|---|---|---|---|
| Brookfield LV | spindle 2 | spindle 2 @ | Spindle 2 | spindle 3 | Spindle 4 |
| viscometer setting³ | @ 60 rpm | 60 rpm | @ 60 rpm | @ 60 rpm | @ 60 rpm |
| Viscosity (cps) | 30 | 90 | 300 | 1020 | 3200 |
| 60° gloss⁴ | 35 | 11 | 8 | 30 | 57 |

¹An aqueous anionic, aliphatic polyetherurethane dispersion comprising a polyurethane having terminal methylol groups (solids content of about 30%), Bayer MaterialScience LLC.
²An aqueous anionic acrylic polymer solution having a viscosity of 25,000 to 60,000 mPa · s at 20° C. when measured according to DIN EN ISO 3219 at a non-volatile content of 9% to 11% by weight, based on the total weight of the solution, measured according to DIN 53189, OMG Borchers GmbH.
³Brookfield viscosities were measured using a Brookfield Viscometer Model LVF using the spindle and speed (in revolutions per minute) listed in the table. All viscosity measurements were taken at a temperature of 20-25° C.
⁴Specular gloss was measured using a BYK Gardner Micro-TRI-Gloss meters using the 60° glossmeter geometry. Reported results (in gloss units) are an average of at least three measurements at different panel locations.

### Example 2

Example 2A was prepared using the ingredients and amounts (in grams) listed in Table 2. Component 1 and component 2 were mixed using a mixing blade on a IKA Labortechnik Eurostar power control-visc under a shear rate of 500-600 minute⁻¹ until evenly distributed. Component 3 was then dropped directly into the combined polyurethane dispersions and mixed under a shear rate of 500-600 minute⁻¹ until completely dispersed. Within 30 minutes after mixing, the formulation was then drawn down onto an unpolished B-952 metal panel using a 5 mil bar, allowed to flash for 5 minutes, and then baked at 90° C. for 5 minutes. After cooling, the coating was evaluated for 60° gloss. Results are set forth in Table 2.

Example 2B was prepared using the ingredients and amounts (in grams) listed in Table 2. Component 1 and component 3 were mixed using a mixing blade on a IKA Labortechnik Eurostar power control-visc under a shear rate of 500-600 minute⁻¹ until evenly distributed. Component 2 was added and mixed under a shear rate of 500-600 minute⁻¹ until completely dispersed. Within 30 minutes after mixing, the formulation was then drawn down onto an unpolished B-952 metal panel using a 5 mil bar, and then allowed to flash for 5 minutes, then baked at 90° C. for 5 minutes. After cooling, the coated substrate was evaluated for 60° gloss. Results are set forth in Table 2.

TABLE 2

| | | |
|---|---|---|
| Component | Material | Amount |

Example 2A

| | | |
|---|---|---|
| 1 | IMPRANIL ® 43032¹ | 75 |
| 2 | IMPRANIL ® DL 1554⁵ | 25 |
| 3 | Borchi ® Gel A LA² | 1.5 |

Test Results

| | |
|---|---|
| % solids | 37.5 |
| Brookfield LV viscometer setting³ | Spindle 3 @ 40 rpm |
| Viscosity | 640 cps |
| 60° Gloss⁴ | 25 |

Example 2B

| | | |
|---|---|---|
| 1 | IMPRANIL ® 43032¹ | 75 g |
| 3 | IMPRANIL ® DL 1554⁵ | 25 g |
| 2 | Borchi ® Gel A LA² | 1.5 g |

Test Results

| | |
|---|---|
| % solids | 37.5 |
| Brookfield LV viscometer setting³ | spindle 2 @ 30 rpm |
| Viscosity | 750 cps |
| 60° Gloss⁴ | 14 |

⁵An aqueous anionic, aliphatic polyester-polyurethane dispersion (solids content of about 60%), Bayer MaterialScience LLC.

### Example 3

Various compositions (3A-3F) were prepared by first preparing a Master Batch by mixing 240 grams of IMPRANIL® 43032 with 4.8 g of Borchi® Gel A LA using a mixing blade on a IKA Labortechnik Eurostar power control-visc under a shear rate of 500-600 minute⁻¹ until evenly dispersed. Then, 160 g of IMPRANIL® DL 1554 was added to the first mixture. This translates to a weight ratio of 75 parts IMPRANIL® 43032:1.5 parts Borchi® Gel A LA:50 parts IMPRANIL® DL 1554. Since, IMPRANIL® 43032 has a solids content of 30% and IMPRANIL® DL 1554 has a solids content of 60%, the master batch had an overall polyurethane solids content of 53%. For compositions 3A-3F, various amounts of water (in grams) were added to varying amounts of the master batch (in grams) to decrease the overall solids content of the given mixture. Within 30 minutes after mixing, each composition was then drawn down onto an unpolished B-952 metal panel using a 5 mil bar, allowed to flash for 5 minutes, and then baked at 90° C. for 5 minutes. Results are set forth in Table 3.

TABLE 3

| Component | 3A | 3B | 3C | 3D | 3E | 3F |
|---|---|---|---|---|---|---|
| Master Batch | 100 | 95 | 85 | 76 | 57 | 38 |
| Water | 0 | 5 | 14 | 24 | 43 | 62 |
| solids content | 53% | 50% | 45% | 40% | 30% | 20% |
| Brookfield LV | Spindle 3 | Spindle 2 | Spindle 2 | Spindle 2 | Spindle 2 | Spindle 2 |
| viscometer setting³ | @ 60 rpm | @ 60 rpm | @ 60 rpm | @ 60 rpm | @ 60 rpm | @ 60 rpm |
| Viscosity (cps) | 660 | | 110 | 55 | 25 | 10 |
| 60° gloss⁴ | 45 | 35 | 11 | 10 | 9 | 13 |
| Dry film thickness | 1 | 0.9 | 0.8 | 0.75 | 0.5 | 0.35 |

### Example 4

Various compositions (4A-4D) were prepared by mixing components 1 and 2 in the amounts (in grams) listed in Table 4 using a mixing blade on a IKA Labortechnik Eurostar power control-visc under a shear rate of 500-600 minute⁻¹ until evenly dispersed. Then component 3 was added under shear. Within 30 minutes after mixing, each formulation was then drawn down onto two unpolished B-952 metal panels using a 5 mil bar. One of the panels was allowed to air dry in a room temperature area for half of a day (“Panel 1”), and the other panel was allowed to flash for 45 minutes and then baked in a 90° C. oven for 5 minutes (“Panel 2”). Results are set forth in Table 4.

TABLE 4

| Component # | Ingredient | 4A | 4B | 4C | 4D |
|---|---|---|---|---|---|
| 1 | IMPRANIL ® 43032¹ | 75 | 75 | 75 | 75 |
| 2 | Borchi ® Gel A LA² | 1.5 | 1.5 | 1.5 | 1.5 |
| 3 | IMPRANIL ® DL 1554⁵ | — | 25 | — | 50 |
| 3 | IMPRANIL ® DLC-F⁶ | — | — | 25 | — |

Test Results

| | | | | |
|---|---|---|---|---|
| solids content | 31% | 38% | 33% | 43% |
| 60° gloss - Panel 1 | 8 | 12 | 10 | 39 |
| 60° gloss - Panel 2 | 7 | 10 | 10 | 36 |

⁶An aqueous anionic polycarbonate ester polyurethane dispersion (solids content of about 40%), Bayer MaterialScience LLC.

### Example 5

A composition was prepared by mixing components 1 and 3 in the amounts (in grams) listed in Table 4 using a mixing blade on a IKA Labortechnik Eurostar power control-visc under a shear rate of 500-600 minute⁻¹ until evenly dispersed. Then component 2 was then blended into the mixture. Within 30 minutes after mixing, this formulation was then drawn down onto an unpolished B-952 metal panel using a 10 mil bar, and then allowed to flash for 2-3 hours, then baked at 150° C. for 10 minutes. The formulation also sat covered for one week and was mixed again prior to application using a tongue depressor, and was then drawn down within 30 minutes of such mixing onto an unpolished B-952 metal panel using a 10 mil bar, allowed to flash for 3 minutes, and then baked at 150° C. for 10 minutes. The formulation then sat an additional week (two weeks from its creation date), was mixed again prior to application using a tongue depressor, then (within 30 minutes of such mixing) was drawn down onto an unpolished B-952 metal panel using a 10 mil bar, allowed to flash for 3 minutes, and then baked at 150° C. for 10 minutes. Results are set forth in Table 5.

TABLE 5

| Component | Example 5 | |
|---|---|---|
| 1 | IMPRANIL ® 43032¹ | 75 |
| 2 | IMPRANIL ® DLC-F⁶ | 25 |
| 3 | Borchi ® Gel A LA² | 1.5 |

Test Results

| | |
|---|---|
| Brookfield LV viscometer setting³ | Spindle 2 @ 60 rpm |
| viscosity (cps) | 265 |
| initial 60° gloss⁴ | 10.5 |
| 60° gloss⁴ after 1 wk | 32 |
| 60° gloss⁴ after 2 wk | 60 |

### Example 6

Compositions 6A-6P were each prepared by mixing components 1 and 2 in the amounts (in grams) listed in Table 6 using a mixing blade on a IKA Labortechnik Eurostar power control-visc under a shear rate of 500-600 minute⁻¹. Within 30 minutes after mixing, the formulation was drawn down onto an unpolished B-952 metal panel using a 5 mil bar, allowed to flash for 5 minutes, and then baked at 90° C. for 5 minutes. Results are set forth in Table 6.

TABLE 6

| Component | Ingredient | 6A | 6B | 6C | 6D | 6E |
|---|---|---|---|---|---|---|
| 1 | Impranil ® LP | 75 | 75 | 75 | 75 | 75 |
| | DSB 1069⁷ | | | | | |
| 2 | Borchi ® Gel A | 0.5 | 1 | 1.5 | 2 | 2.5 |
| | LA² | | | | | |

Test Results

| Brookfield LV viscometer | | spindle 4 | spindle 4 | spindle 4 | spindle 4 | spindle 4 |
|---|---|---|---|---|---|---|
| setting³ | | @ 60 rpm | @ 30 rpm | @ 12 rpm | @ 3 rpm | @ 0.6 rpm |
| Viscocity (cps) | | 7300 | 17800 | 44500 | 182000 | 960000 |
| 60° Gloss⁴ | | 85 | 82 | 78 | 65 | 73 |
| Component | Ingredient | 6F | 6G | 6H | 6I | 6J |
| 1 | IMPRANIL ® | 75 | 75 | 75 | 75 | 75 |
| | DLC-F⁶ | | | | | |
| 2 | Borchi ® Gel A | 0.5 | 1 | 1.5 | 2 | 2.5 |
| | LA² | | | | | |

Test Results

| Brookfield LV viscometer | | spindle 4 | spindle 4 | spindle 4 | spindle 4 | spindle 4 |
|---|---|---|---|---|---|---|
| setting³ | | @ 60 rpm | @ 60 rpm | @ 60 rpm | @ 60 rpm | @ 30 rpm |
| Viscocity (cps) | | 2400 | 4800 | 6900 | 8700 | 16200 |
| 60° Gloss⁴ | | 86 | 87 | 87 | 84 | 84 |
| 1 | IMPRANIL ® DL | 75 | 75 | 75 | 75 | 75 |
| | 1554⁵ | | | | | |
| 2 | Borchi ® Gel A | 0.5 | 1 | 1.5 | 2 | 2.5 |
| | LA² | | | | | |

Test Results

| | | | | | |
|---|---|---|---|---|---|
| Brookfield LV viscometer | spindle 4 | spindle 4 | spindle 4 | spindle 4 | spindle 4 |
| setting³ | @ 60 rpm | @ 60 rpm | @ 12 rpm | @ 12 rpm | @ 6 rpm |
| Viscocity (cps) | 7000 | 9700 | 46500 | 49500 | 93000 |
| 60° Gloss⁴ | 65 | 61 | 60 | 55 | 55 |

⁷An aqueous, aliphatic polyether-polyurethane dispersion (solids content of about 50%), Bayer MaterialScienece AG.

### Example 7

Compositions 7A-7D were each prepared by mixing components 1 and 2 in the amounts (in grams) listed in Table 7 using a mixing blade on a IKA Labortechnik Eurostar power control-visc under a shear rate of 500-600 minute⁻¹. Within 30 minutes after mixing, the formulation was drawn down onto an unpolished B-952 metal panel using a 5 mil bar, allowed to flash for 5 minutes, and then baked at 90° C. for 5 minutes. Results are set forth in Table 7.

TABLE 7

| Component | Ingredient | 7A | 7B | 7C | 7D |
|---|---|---|---|---|---|
| 1 | IMPRANIL ® 43032¹ | 75 | 50 | 25 | 75 |
| 2 | Bayhydrol ® AH XP 2741⁸ | 25 | 50 | 75 | 1.5 |

Test Results

| | | | | |
|---|---|---|---|---|
| Brookfield LV viscometer setting³ | spindle 2 | spindle 2 | spindle 2 | spindle 2 @ |
| Viscosity (cps) | @ 60 rpm | @ 60 rpm | @ 60 rpm | 60 rpm |
| 60° gloss⁴ | 15 | 15 | 15 | 15 |
| | 98 | 98 | 98 | 97 |

⁸An aqueous core-shell styrene acrylate dispersion (solids content of about 40%), Bayer MaterialScience AG.

### Example 8

Compositions 8A-8D were each prepared by mixing components 1 and 2 in the amounts (in grams) listed in Table 8 using a mixing blade on a IKA Labortechnik Eurostar power control-visc under a shear rate of 500-600 minute⁻¹. When used, component 3 was then blended into the mixture. Within 30 minutes after mixing, these formulations were each drawn down onto an unpolished B-952 metal panel using a 5 mil bar, allowed to flash for 5 minutes, and then baked at 90 C for 5 minutes. Results are set forth in Table 8.

TABLE 8

| Com- | | | | | | | |
|---|---|---|---|---|---|---|---|
| po- | | | | | | | |
| nent | Ingredients | 8A | 8B | 8C | 8D | 8E | 8F |
| 1 | IMPRANIL ® 43032¹ | 75 | 75 | 75 | 100 | 100 | 100 |
| 3 | IMPRANIL ® DL 1554⁵ | — | — | 25 | — | — | — |
| 3 | IMPRANIL ® DLC-F⁶ | 25 | 25 | | — | — | — |
| 2 | ACRYSOL ™ TT-615⁹ | 1.5 | 0.5 | 1 | — | — | — |
| 2 | Rheovis ® AS 1188¹⁰ | — | — | — | 0.5 | — | — |
| 2 | Viscalex ® AS 1130¹¹ | — | — | — | — | 0.5 | 1.5 |

Test Results

| | | | | | | |
|---|---|---|---|---|---|---|
| 60° gloss⁴ | 90 | 91 | 86 | n/a* | 85 | 90 |

⁹A hydrophobically modified alkali swellable emulsion which is not pre-neutralized and which has a solids content of 30% and a Brookfield Viscosity (1 at 60) of 26 cps maximum, The Dow Chemical Company.
¹⁰A pre-neutralized, acrylic/acrylamide copolymer which has a solids content of 60% in mineral oil, BASF.
¹¹An alkali swellable acrylic copolymer emulsion in water which is not pre-neutralized and which has a solids content of 30% and a Brookfield Viscosity at 25° C. of ~40 mPa · s, BASF.
*A continuous mixture of component 1 and component 2 was not obtained.

### Example 9

Compositions 9A-9C were each prepared by mixing components 1 and 2 in the amounts (in grams) listed in Table 9 using a mixing blade on a IKA Labortechnik Eurostar power control-visc under a shear rate of 500-600 minute⁻¹ until evenly dispersed. Component 3 was then blended into the mixture, followed by component 4. Within 30 minutes after mixing, these formulations were each drawn down onto an unpolished B-952 metal panel using a 5 mil bar, allowed to flash for 5 minutes, and then baked at 90° C. for 5 minutes. Results are set forth in Table 9.

TABLE 9

| Com- | | | | |
|---|---|---|---|---|
| ponent | Ingredient | 9A | 9B | 9C |
| 1 | IMPRANIL ® 43032¹ | 75 | 75 | 75 |
| 2 | Borchi ® Gel A LA² | 1.5 | 1.5 | 1.5 |
| 3 | IMPRANIL ® DL 1554⁵ | 25 | 25 | 25 |
| 4 | Borchi Gel L 75 N¹² | 0.3 | — | — |
| 4 | Acrysol ® RM-825¹³ | | 0.3 | — |
| 4 | Borchi ® Gel LW 44¹⁴ | — | — | 0.3 |

Test Results

| | | | |
|---|---|---|---|
| Brookfield LV viscometer setting³ | spindle 4 | spindle 4 | spindle 4 |
| Viscosity (cps) | @ 60 rpm | @ 60 rpm | @ 60 rpm |
| 60° gloss | 7400 | 6000 | 5600 |
| | 70 | 68 | 60 |

¹²Non-ionic polyurethane, non-volatile content 48-52% according to ISO 3251, Viscosity max, 9,000 mPa · s according to DIN EN ISO 3219 (A.3 rotation) (23° C.), OMG Borchers GmbH
¹³non-ionic urethane, solids Content 25%, Brookfield Viscosity of 1000-2500 cps, The Dow Chemical Company
¹⁴Non-ionic polyurethane, non-volatile content 45-49% according to ISO 3251, viscosity max. 9,000 mPa · s DIN EN ISO 3219 (A.3 rotation) (23° C.), OMG Borchers GmbH

### Example 10

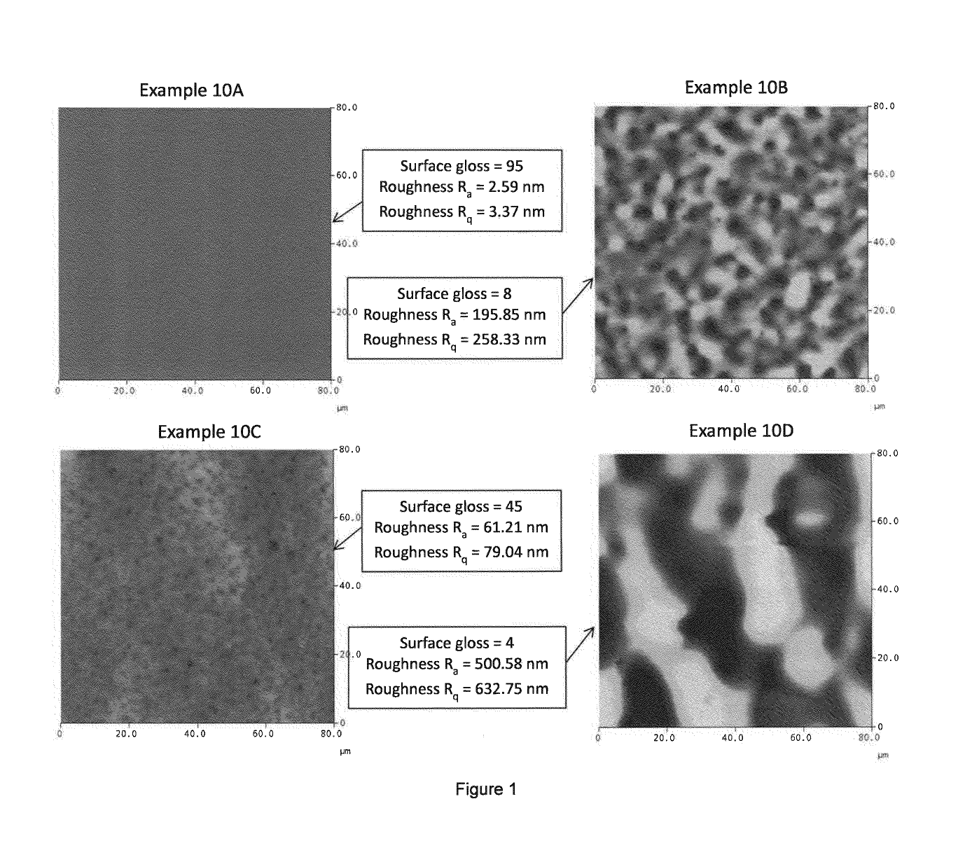

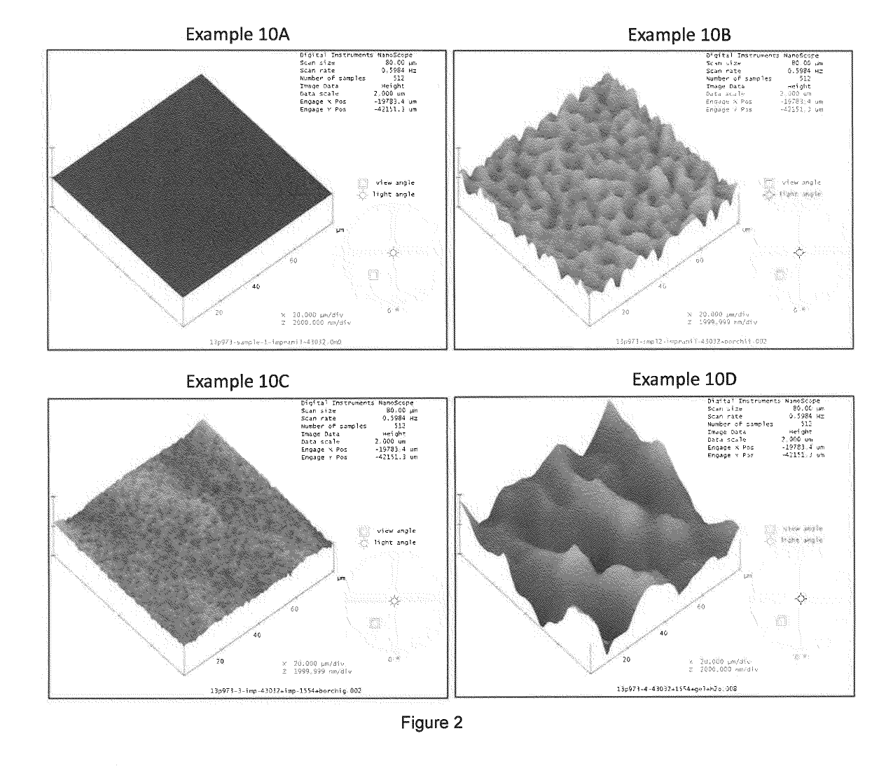

For Example 10A, IMPRANIL® 43032 was drawn down on a cardboard paper sheet using a 5 mil bar to yield a 60° gloss of 95 and an average deviation surface roughness (Ra) of 2.59 nm as determined by atomic force microscope as described above (see FIGS. 1 and 2).

For Example 10B, 75 grams of IMPRANIL® 43032 was mixed with 1.5 g of Borchi® Gel A LA using a mixing blade on a IKA Labortechnik Eurostar power control-visc under a shear rate of 500-600 minute⁻¹ until evenly dispersed. Within 30 minutes after mixing, the formulation was drawn down on a cardboard paper sheet using a 5 mil bar to yield a 60° gloss of 8 and an average deviation surface roughness (Ra) of 195.85 nm as determined by atomic force microscope as described above (see FIGS. 1 and 2).

For Example 10C, 75 g of IMPRANIL® 43032 was mixed with 1.5 g of Borchi® Gel A LA using a mixing blade on a IKA Labortechnik Eurostar power control-visc under a shear rate of 500-600 minute⁻¹ until evenly dispersed. Then, 50 g of IMPRANIL® DL 1554 was added and mixed. Within 30 minutes after mixing, the formulation was drawn down on a cardboard paper sheet using a 5 mil bar to yield a 60° gloss of 45 and an average deviation surface roughness (Ra) of 61.21 nm as determined by atomic force microscope as described above (see FIGS. 1 and 2).

For Example 10D, 75 g of IMPRANIL® 43032 was mixed with 1.5 g of Borchi® Gel A LA using a mixing blade on a IKA Labortechnik Eurostar power control-visc under a shear rate of 500-600 minute⁻¹ until evenly dispersed. Then 50 g of IMPRANIL® DL 1554 was added and mixed. To cut the solids down from 53% to 40%, 76 g of the mixture was added to 24 g of water. Within 30 minutes after mixing, the formulation was drawn down on a cardboard paper sheet using a 10 mil bar because it had little viscosity to yield a 60° gloss of 4 and an average deviation surface roughness (Ra) surface roughness of 500.58 nm as determined by atomic force microscope as described above (see FIGS. 1 and 2).

### Example 11

Various compositions (11A-11D) were prepared by mixing the ingredients and amounts (in grams) listed in Table 11 using a mixing blade on a IKA Labortechnik Eurostar power control-visc under a shear rate of 500-600 minute⁻¹ until evenly distributed. Each formulation was then immediately drawn down onto an unpolished B-952 metal panel using a 5 mil bar, and then allowed to flash for 5 minutes, then baked at 90° C. for 5 minutes. After cooling, the coating was evaluated for 60° gloss and for appearance. Gloss was measured using a gloss meter 3 times on each panel and the results reflect an average of the readings obtained. Application and testing was repeated each hour for 8 hours. Prior to each hourly application, the formulation was remixed by hand using a tongue depressor until the formulation was again uniformly mixed. For each hourly application, the coating was applied and cured in the same manner as the initial application. Results are set forth in Table 11.

TABLE 11

| Ingredient | 11A | 11B | 11C | 11D |
|---|---|---|---|---|
| MPRANIL ® 43032¹ | 100 | 100 | 100 | 100 |
| Borchi ® Gel A LA² | 1.0 | 1.5 | 2.0 | 2.5 |

Test Results (60°Gloss/Appearance)¹⁵

| | | | | |
|---|---|---|---|---|
| Initial gloss | 13.8/Good | 12.8/Good | 7.9/Good | 24.9/Good |
| 1 hr | 13 9/Good | 18.0/Good | 11.2/Good | 35.6/Good |
| 2 hr | 17.4/Good | 8.4/Good | 12.7/Good | 43.4/Good |
| 3 hr | 18.0/Good | 9.2/Good | 13.4/Good | 52.8/Good |
| 4 hr | 14.9/Good | 8.3/Good | 12.4/Good | 50.7/Good |
| 5 hr | 13.5/Good | 9.4/Good | 14.9/Good | 51.8/Good |
| 6 hr | 13.5/Good | 10.1/Good | 18.2/Good | 54.4/Good |
| 7 hr | 18.2/Good | 9.7/Good | 17.7/Good | 56.0/Good |
| 8 hr | 21.2/Good | 9.8/Good | 18.6/Good | 52.0/Good |

¹⁵“Good” appearance means that the coating did not have any visually observable imperfections to the naked eye, whereas “Poor” means that the coating exhibited visually observable “swirls” or “streaks”.

### Example 12

Various compositions (12A-12D) were prepared by mixing the ingredients and amounts (in grams) listed in Table 12 using a mixing blade on a IKA Labortechnik Eurostar power control-visc under a shear rate of 500-600 minute-1 until evenly distributed. Each formulation was then immediately drawn down onto an unpolished B-952 metal panel using a 5 mil bar, and then allowed to flash for 5 minutes, then baked at 90° C. for 5 minutes. After cooling, the coating was evaluated for 60° gloss and for appearance. Gloss was measured using a gloss meter 3 times on each panel and the results reflect an average of the readings obtained. Application and testing was repeated each hour for 8 hours. Prior to each hourly application, the formulation was not remixed. For each hourly application, the coating was applied and cured in the same manner as the initial application. Results are set forth in Table 12.

TABLE 12

| Ingredient | 12A | 12B | 12C | 12D |
|---|---|---|---|---|
| IMPRANIL ® 43032¹ | 100 | 100 | 100 | 100 |
| Borchi ® Gel A LA² | 1.0 | 1.5 | 2.0 | 2.5 |

Test Results (60°Gloss/Appearance)¹⁷

| | | | | |
|---|---|---|---|---|
| Initial gloss | 10.3/Good | 9.1/Good | 10.7/Good | 30.2/Good |
| 1 hr | 12.8/Good | 9.7/Good | 13.2/Good | 30.7/Poor |
| 2 hr | 12.6/Poor | 10.4/Poor | 12.3/Good | 24.3/Poor |
| 3 hr | *9.6-52.7/Poor | 10.2/Poor | 15.5/Good | *6.3-27.8/Poor |
| 4 hr | *6.6-26.8/Poor | 8.9/Poor | 14.4/Poor | 25.2/Poor |
| 5 hr | *6.1-24.9/Poor | 8.4/Poor | 12.9/Poor | 31.9/Poor |
| 6 hr | *8.7-68.1/Poor | 10.9/Poor | 14.9/Poor | 28.3/Poor |
| 7 hr | *12.7-68.2/Poor | *13.4-81.0/Poor | 11.9/Poor | 28.3/Poor |
| 8 hr | *68.8-91.6/Poor | *9.5-28.2/Poor | 15.6/Poor | 25.2/Poor |

*Film was not uniform, so inconsistent gloss values were obtained.

### Example 13

Various compositions (13A-13C) were each prepared by mixing components 1 and 2 in the amounts (in grams) listed in Table 13 using a mixing blade on a IKA Labortechnik Eurostar power control-visc under a shear rate of 500-600 minute⁻¹. Then, component 3 was blended into the mixture. Then component 4, the flattening agent, was gradually added to the mixture under shear. Within 30 minutes after mixing, these formulations were each drawn down onto an unpolished B-952 metal panel using a 5 mil bar, allowed to flash for 5 minutes, and then baked at 90 C for 5 minutes. Results are set forth in Table 13.

TABLE 13

| Com- | | | | |
|---|---|---|---|---|
| ponent | Ingredient | 13A | 13B | 13C |
| 1 | IMPRANIL ® 43032¹ | 75 | 75 | 75 |
| 2 | Borchi ® Gel A LA² | 1.5 | 1.5 | 1.5 |
| 3 | IMPRANIL ® DL 1554⁵ | 25 | 25 | 25 |
| 4 | ACEMATT ® OK 412¹⁶ | 2 | 5 | 8 |

| | | | |
|---|---|---|---|
| Brookfield LV viscometer setting³ | Spindle 3 | Spindle 4 | Spindle 4 |
| Viscosity (cps) | @ 60 rpm | @ 60 rpm | @ 60 rpm |
| 60° gloss⁴ | 1100 | 3900 | 5000 |
| | 18* | 5.5 | 3.5 |

¹⁶Silicon dioxide with organic surface-treatment, average agglomerate particle size (median TEM) = 3 μm, Evonik Industries AG
*This film exhibited a higher gloss than expected, which is believed to have been caused by experimental/human error.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method for coating a substrate, comprising depositing a two-component coating composition comprising a first component and a second component over the substrate to form a film having a 60° gloss of no more than 35 gloss units measured according to ASTM D523-89,
wherein:
(i) the first component comprises an aqueous anionic, aliphatic polyurethane dispersion comprising a polyurethane having terminal methylol groups; and
(ii) the second component comprises an aqueous anionic acrylic polymer solution having a viscosity of 25,000 to 60,000 mPa·s at 20° C. when measured according to DIN EN ISO 3219 at a non-volatile content of 9% to 11% by weight, based on the total weight of the solution, measured according to DIN 53189.

2. The method of claim 1, wherein the substrate comprises a textile.

3. The method of claim 2, wherein the textile comprises synthetic leather.

4. The method of claim 1, wherein the film has a 60° gloss of no more than 15 gloss units.

5. The method of claim 1, wherein the anionic, aliphatic polyurethane dispersion comprises a polyether-polyurethane dispersion comprising sultanate groups.

6. The method of claim 1, wherein the polyurethane having terminal methylol groups is a reaction product of a hydrophilically modified acylated amine functional polyurethane prepolymer and formaldehyde.

7. The method of claim 6, wherein the hydrophilically modified acylated amine functional polyurethane prepolymer has acylated amino groups of the formula: —X—NHR, wherein X is —CO—, —CS—, —SO₂—, —NR—CO—, —NR—CS—, —O—CO—, —S—CO—, —O—CS—, —O—SO₂—, —CNR—, —NR—CNR—, —CO—NR—CO—, —CS—NR—CS—, 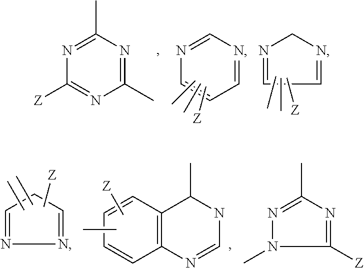
in which Z is —NHR, 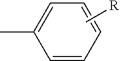
or R, in which R is H or an alkyl radical or alkenyl radical having 1 to 4 carbon atoms and which may also be part of a heterocyclic 5-membered or 6-membered ring with 1 to 3 heteroatoms, and which may be substituted by OH, OCH₃, OC₂H₅, CCl₃, COOH, or SO₃H, or R is CN, CO—R′, SO₂—R′, in which R′ is an alkyl, alkenyl, alkoxy, or carboxyl radical with 1 to 4 carbon atoms.

8. The method of claim 7, wherein the acylated amino groups are of the formula: —NH—CO—NH₂.

9. The method of claim 1, wherein (ii) is present in the coating composition in an amount such that the acrylic polymer that is in the solution is present in an amount of 0.2 to 1 percent by weight, based on the weight of resin solids in (i).

10. The method of claim 9, wherein (ii) is present in the coating composition in an amount such that the acrylic polymer that is in the solution is present in an amount of 0.4 to 0.7 percent by weight, based on the weight of resin solids in (i).

11. The method of claim 1, wherein the coating composition comprises (iii) an aqueous anionic, aliphatic polyurethane dispersion different from (ii).

12. The method of claim 1, wherein (iii) comprises a polyester-polyurethane, a polyether-polyurethane, a polyacrylic-polyurethane and/or a polycarbonate-polyurethane.

13. The method of claim 1, wherein the mixture further comprises a flatting agent present in an amount of no more than 5 percent by weight, based on the total weight of the mixture, and the 60° gloss is no more than 5 gloss units.

14. The method of claim 13, wherein the 60° gloss is no more than 2 gloss units.

15. A substrate coated according to the method of claim 1.

16. A method comprising:
(a) mixing a first component and a second component to make a mixture thereof, wherein:
(1) the first component comprises a first aqueous anionic, aliphatic polyurethane dispersion comprising a condensation reaction product of a polyurethane prepolymer having terminal methylol groups; and
(2) the second component comprises an aqueous anionic acrylic polymer solution having a viscosity of 25,000 to 60,000 mPa·s at 20° C. measured according to DIN EN ISO 3219 at a non-volatile content of 9% to 11% by weight, based on the total weight of the solution, measured according to DIN 53189,
for a time and under conditions so as to disperse (2) in the mixture; and
(b) adding a second aqueous polyurethane dispersion, different from (1), to the mixture of step (a) such that the resin solids content of the aqueous polyurethane dispersion is less than 50% by weight, based on the total weight of the aqueous polyurethane dispersion.

17. The method of claim 16, wherein the anionic, aliphatic polyurethane dispersion comprises a polyether-polyurethane dispersion comprising sulfonate groups.

18. The method of claim 16, wherein the polyurethane having terminal methylol groups is a reaction product of a hydrophilically modified acylated amine functional polyurethane prepolymer and formaldehyde.

19. The method of claim 16, wherein (2) is present in the coating composition in an amount such that the acrylic polymer that is in the solution is present in an amount of 0.2 to 1 percent by weight, based on the weight of resin solids in (1).

20. The method of claim 19, wherein (2) is present in the coating composition in an amount such that the acrylic polymer that is in the solution is present in an amount of 0.4 to 0.7 percent by weight, based on the weight of resin solids in (1).

21. The method of claim 16, wherein (b) comprises a polyester-polyurethane, a polyether-polyurethane a polyacrylic-polyurethane and/or a polycarbonate-polyurethane.

22. The method of claim 16, further comprising depositing the dispersion over a substrate to form a film having a 60° gloss of no more than 35 gloss units measured according to ASTM D523-89.

23. The method of claim 22, wherein the dispersion further comprises a flatting agent present in an amount of no more than 5 percent by weight, based on the total weight of the mixture, and the 60° gloss is no more than 5 gloss units.

24. The method of claim 23, wherein the 60° gloss is no more than 2 gloss units.

25. The method of claim 23, wherein the substrate comprises a textile.

26. The method of claim 25, wherein the textile comprises synthetic leather.

27. A method for coating a substrate, comprising depositing a two-component coating composition comprising a first component and a second component to make a mixture thereof over the substrate within 2 hours after the mixture has been prepared to form a film having a 60° gloss of no more than 35 gloss units measured according to ASTM D523-89,
wherein:
(i) the first component comprises an aqueous anionic, aliphatic polyether-polyurethane dispersion comprising a polyurethane having terminal methylol groups and sulfonate groups and comprising a reaction product of a hydrophilically modified acylated amine functional polyurethane prepolymer and formaldehyde;
(ii) the second component comprises an aqueous anionic acrylic polymer solution having a viscosity of 25,000 to 60,000 mPa·s at 20° C. when measured according to DIN EN ISO 3219 at a non-volatile content of 9% to 11% by weight, based on the total weight of the solution, measured according to DIN 531899, wherein (ii) is present in the coating composition in an amount such that the acrylic polymer that is in the solution is present in an amount of 0.2 to 1 percent by weight, based on the weight of resin solids in (i); and
(iii) the resin solids content of the mixture is less than 50% by weight, based on the total weight of the coating composition.

28. The method of claim 1, wherein the substrate comprises a textile comprising synthetic leather.

29. The method of claim 27, wherein the hydrophilically modified acylated amine functional polyurethane prepolymer has acylated amino groups of the formula: —X—NHR, wherein X is —CO—, —CS—, —SO₂—, —NR—CO—, —NR—CS—, —O—CO—, —S—CO—, —O—CS—, —O—SO₂—, —CNR—, —NR—CNR—, —CO—NR—CO—, —CS—NR—CS—, 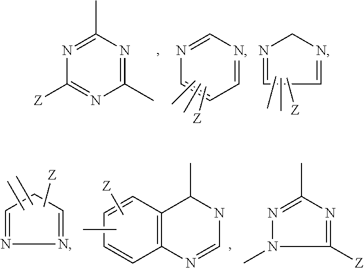
in which Z is —NHR, 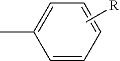
or R, in which R is H or an alkyl radical or alkenyl radical having 1 to 4 carbon atoms and which may also be part of a heterocyclic 5-membered or 6-membered ring with 1 to 3 heteroatoms, and which may be substituted by OH, OCH₃, OC₂H₅, CCl₃, COOH, or SO₃H, or R is CN, SO₂—R′, in which R′ is an alkyl, alkenyl, alkoxy, or carboxyl radical with 1 to 4 carbon atoms.

30. The method of claim 28, wherein the acylated amino groups are of the formula: —NH—CO—NH₂.

31. The method of claim 27, wherein (ii) is present in the coating composition in an amount such that the acrylic polymer that is in the solution is present in an amount of 0.4 to 0.7 percent by weight, based on the weight of resin solids in (i).

32. The method of claim 27, wherein the coating composition comprises an aqueous anionic, aliphatic polyurethane dispersion different from (ii) which comprises a polyester-polyurethane, a polyether-polyurethane, a polyacrylic-polyurethane and/or a polycarbonate-polyurethane.

33. The method of claim 27, wherein the mixture further comprises a flatting agent present in an amount of no more than 5 percent by weight, based on the total weight of the mixture, and the 60° gloss is no more than 5 gloss units.

34. The method of claim 33, wherein the 60° gloss is no more than 2 gloss units.

35. The method of claim 27, wherein the resin solids content of the mixture is no more than 45% by weight, based on the total weight of the aqueous polyurethane dispersion.
